(19) United States
(12) Patent Application Publication
(10) Pub. No.: US 2010/0083206 A1
(43) Pub. Date: Apr. 1, 2010

(54) Clock signal providing circuit designing method, information processing apparatus and computer-readable information recording medium

(75) Inventor: Tatsuhiko Negishi, Kawasaki (JP)

Correspondence Address: STAAS & HALSEY LLP, SUITE 700, 1201 NEW YORK AVENUE, N.W., WASHINGTON, DC, 20005, US

(73) Assignee: FUJITSU LIMITED, Kawasaki (JP)

(21) Appl. No.: 12/585,959

(22) Filed: Sep. 29, 2009

(30) Foreign Application Priority Data
Sep. 30, 2008 (JP) 2008-254634

(51) Int. Cl. G06F 17/50

(52) U.S. Cl. 716/6

(57) ABSTRACT

A clock signal providing circuit designing method for designing a clock signal providing circuit includes grouping circuit elements into a plurality of circuit groups each including a plurality of circuit elements, calculating an evaluation index value for each of the plurality of circuit groups and summing up calculated evaluation index values to obtain a first sum total, exchanging or moving provisionally at least one circuit element between the plurality of circuit groups, calculating an evaluation index value for each of the plurality of circuit groups and summing up calculated evaluation index values to obtain a second sum total, determining whether the second sum total decreases from the first sum total, fixing the circuit element provisionally exchanged or moved when the second sum total decreases from the first sum total and cancelling the circuit element provisionally exchanged or moved when the second sum total increases from the first sum total.

### CROSS-REFERENCE TO RELATED APPLICATIONS

This application is based upon and claims the benefit of priority of the prior Japanese Patent Application No. 2008-254634, filed on Sep. 30, 2008, the entire contents of which are incorporated herein by reference.

### FIELD

The embodiment discussed herein relates to a clock signal providing circuit designing method, an information processing apparatus and a computer-readable information recording medium.

### BACKGROUND

In a technical field of designing a layout of a semiconductor integrated circuit, in which high integration and high speed operation of a semiconductor integrated circuit are remarkably promoted, a clock tree synthesis method (CTS) is used. The clock tree synthesis method is a method for reducing variation in clock signals occurring at destinations of the clock signals.

A semiconductor integrated circuit designing method for designing a semiconductor integrated circuit having a clock tree which branches from a clock providing source into a plurality of groups for respective destinations located at ends of the tree is also known. In the semiconductor integrated circuit designing method, clock tree configuration information is input, and the clock tree configuration is changed in such a manner that a branch portion of the clock tree is located to the tree end side.

[Patent Document 1] Japanese Laid-Open Patent Publication No. 2007-27841

[Patent Document 2] Japanese Laid-Open Patent Publication No. 2007-128429

[Patent Document 3] Japanese Laid-Open Patent Publication No. 7-134626

[Patent Document 4] Japanese Laid-Open Patent Publication No. 11-214517

### SUMMARY

According to an aspect of an invention, a clock signal providing circuit designing method for designing a clock signal providing circuit includes grouping circuit elements into a plurality of circuit groups each of which includes a plurality of circuit elements, calculating an evaluation index value for each of the plurality of circuit groups and summing up calculated evaluation index values to obtain a first sum total, exchanging or moving provisionally at least one circuit element between the plurality of circuit groups, calculating an evaluation index value for each of the plurality of circuit groups and summing up calculated evaluation index values to obtain a second sum total, determining whether the second sum total decreases from the first sum total, fixing the circuit element provisionally exchanged or moved in a case where the second sum total decreases from the first sum total and cancelling the circuit element provisionally exchanged or moved in a case where the second sum total increases from the first sum total.

### BRIEF DESCRIPTION OF DRAWINGS

FIG. 1 depicts a flow of data in a clock signal providing circuit designing method in an embodiment;

FIG. 2 depicts a basic flow of algorithm of grouping flip-flop circuits in FIG. 1;

FIG. 3 depicts a flow of operation of initial grouping in FIG. 2;

FIGS. 4A, 4B, 4C, 4D, 4E, 4F and 4G illustrate operation of the initial grouping;

FIGS. 5A and 5B illustrate how to determine an area of a group in the initial grouping;

FIGS. 6A and 6B illustrate examples of states after the initial grouping;

FIGS. 7A, 7B, 7C and 7D illustrate optimization 1 (exchange);

FIGS. 8A, 8B, 8C and 8D illustrate optimization 2 (move);

FIG. 9 depicts an example of a state after the optimization 1 and the optimization 2;

FIGS. 10A, 10B and 10C illustrate optimization 3 (combine);

FIG. 11 illustrates determination for convergence in the grouping;

FIGS. 12A, 12B, 12C and 12D illustrate examples of cases where the optimization 1, the optimization 2 and the optimization 3 are repeated;

FIG. 13 illustrates insertion of clock buffers and provision of clock lines;

FIG. 14 illustrates proving advantage of the embodiment;

FIG. 15 illustrates for verifying effects of the embodiment; and

FIG. 16 illustrates a case where the clock signal providing circuit designing method in the embodiment is realized by a computer.

### DESCRIPTION OF EMBODIMENT

In a semiconductor integrate circuit, a clock buffer (clock driver) is used for providing a clock signal to a circuit element such as a flip-flop circuit (which will be abbreviated as “FF”, hereinafter). The clock buffer means a buffer which has a function to relay a clock signal. A group of circuit elements may be created for providing a clock signal by using a single clock buffer. A “group” means a group of circuit elements for providing a clock signal by using a single clock buffer, hereinafter. Further, creating such a group or groups will be referred to as grouping, hereinafter. According to a clock providing circuit designing method in an embodiment, “grouping” may be carried out efficiently.

That is, In the clock providing circuit designing method in the embodiment, provisional exchanging FFs and/or moving a FF (each of which will be described later) for provisionally changing groups of circuit elements which have been created previously. Then, after the provisional exchanging FFs and/or moving a FF, an evaluation index value (which will be described later) is calculated for each of the groups, and the evaluation index values are summed up for all the groups. When the sum total decreases through the provisional exchanging FFs and/or moving a FF, the provisional exchanging FFs and/or moving a FF is fixed. On the other hand, when the sum total does not decrease through the provisional exchanging FFs and/or moving a FF, the provisional exchanging FFs and/or moving a FF is cancelled. The above-mentioned provisional exchanging FFs and/or moving a FF, calculating the evaluation index values, summing up the evaluation index values, and fixing or canceling the provisional exchanging FFs and/or moving a FF, may be repeated. As a result, designing of a clock signal providing circuit can be effectively carried out for decreasing the sum total of the evaluation index values of the respective groups of the circuit elements. The “evaluation index value” is such that, as the evaluation index value is smaller, a clock signal is advantageously provided to each circuit element via a clock buffer which is provided for each group.

For example, in order to meet a requirement concerning a FF, i.e., set-up timing and hold timing, it is necessary to reduce clock skew. Clock skew means a delay difference possibly occurring between FFs when clock signals are provided to the FFs. Further, because a clock buffer operates frequently, it is preferable to reduce the required number of clock buffers for the purpose of saving power consumption of a semiconductor integrated circuit.

Further, it is preferable to reduce a wiring length from a clock buffer to a FF, and reduce variation in the wring length. A wiring length from a clock buffer to a FF means a length of a wire provided from the clock buffer to the FF for providing a clock signal via the wire. Further, it is preferable that a fanout of a clock buffer is equal to or less than a certain amount. A fanout of a clock buffer means the number of FFs to which clock signals are provided by using the clock buffer. A permissible fanout means a permissible amount of a fanout. It is noted that “grouping” is carried out for each clock domain.

In the clock signal providing circuit designing method in the embodiment, an H tree is created first for providing clock signals to respective FFs in a circuit design for designing a semiconductor integrated circuit. The H tree means a structure of wiring paths used for providing clock signals to circuit elements such as FFs. Then, from an end of the H tree, a clock signal is provided to each FF via a clock buffer through a clock line. The clock line means a wire for providing a clock signal. More specifically, FFs included in a semiconductor integrated circuit is grouped for one or more groups, a clock buffer is allocated for each group of one or more groups, and, from an end of the H tree, a clock line is connected to each clock buffer. Also from each clock buffer to corresponding FFs, clock lines are provided. As a result, the clock lines are provided from the end of the H tree to the respective FFs via each clock buffer. Thus, via the clock lines, clock signals are provided to the respective FFs.

In the embodiment, when the above-mentioned “grouping” is carried out, provisional grouping (referred to as initial groping, hereinafter) is carried out first. Then, “optimization” may be carried out repetitively on the groups obtained from the initial grouping. The “optimization” may include “exchanging FFs” and/or “moving a FF” between groups. Further, each time after “exchanging FFs” and/or “moving a FF”, the above-mentioned evaluation index value is calculated for each group. For example, the evaluation index value may be the sum total of distances each between the center of the group and each FF belonging to the group. Thus-obtained sum totals of evaluation index values are further summed up for all the groups. When the thus-obtained sum total for all of the groups decreases between before and after the “exchanging FFs” and/or “moving a FF”, the “exchanging FFs” and/or “moving a FF” are then fixed and thus, the groups obtained from the “exchanging FFs” and/or “moving a FF” are maintained. On the other hand, when the sum total for all the groups does not decrease between before and after the “exchanging FFs” and/or “moving a FF”, the “exchanging FFs” and/or “moving a FF” are canceled and thus, the groups before the “exchanging FFs” and/or “moving a FF” are maintained. The “optimization” may further include “combining” between groups. Further, the “optimization” may be repeated.

It is noted that, at the center of each group, a clock buffer is provided for providing clock signals to FFs belonging to the group. Therefore, as a distance between the center of each FF is shorter, a clock line connecting from the clock buffer to each FF is shorter accordingly, whereby it is possible to reduce clock skew.

By thus repeating the “optimization”, it is possible to optimize “grouping”. As a result, it is possible to carry out “grouping” of FFs in which clock skew can be effectively reduced in a zone of a high frequency (GHz zone or such).

The “optimization” may be automated by using a computer program. That is, a sequence of processes for carrying out the “optimization” and repeating the “optimization” may be written into an algorithm, and based thereon, a computer program may be created. In this case, a processing amount of the computer program increases linearly with respect to the number of FFs to process. The above-mentioned computer program may be written in such a manner that the processing amount falls within a reasonable amount, and a required memory capacity also falls within a reasonable amount. As the “optimization” is repeated successively, the sum total of the above-mentioned evaluation index values for all the groups, for example, a result of summing up the sum totals of the respective groups each being the sum total of distances each between the center of each group and each FF belonging to the group may converge.

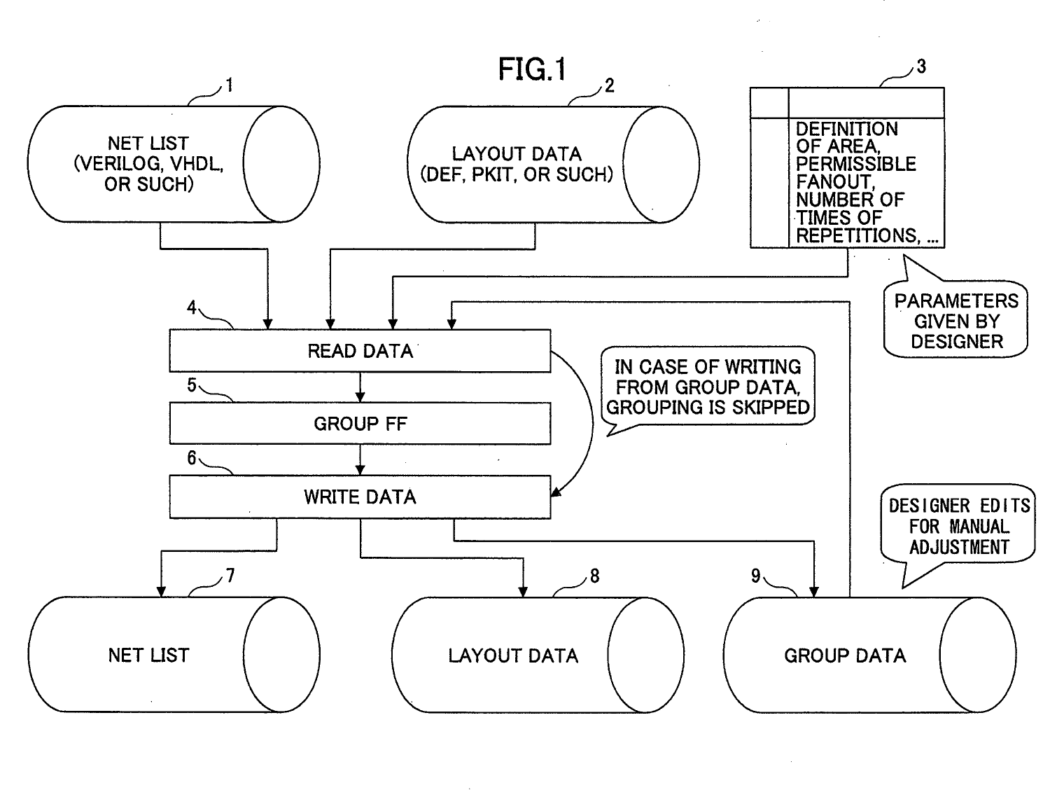

FIG. 1 illustrates a flow of data in the clock signal providing circuit designing method in the embodiment.

In FIG. 1, a designer prepares and inputs to a computer, parameters 3 such as a definition of an “area” of a group, a permissible fanout, the number “n” of times of repetitions of “optimization”, and so forth, in addition to a net list 1 and a layout data 2 of a semiconductor integrated circuit.

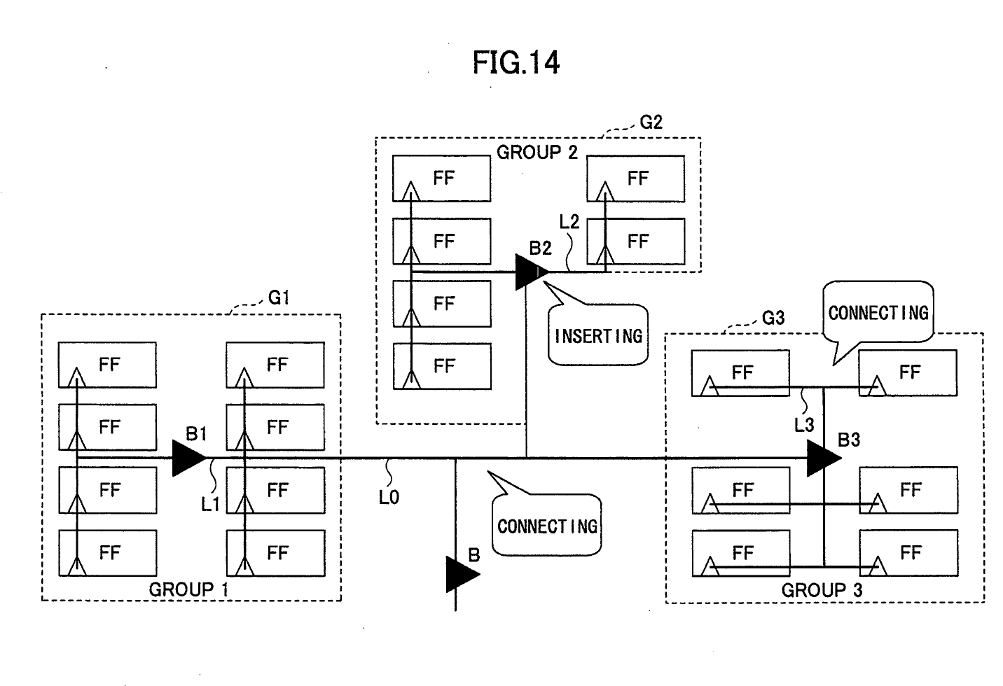

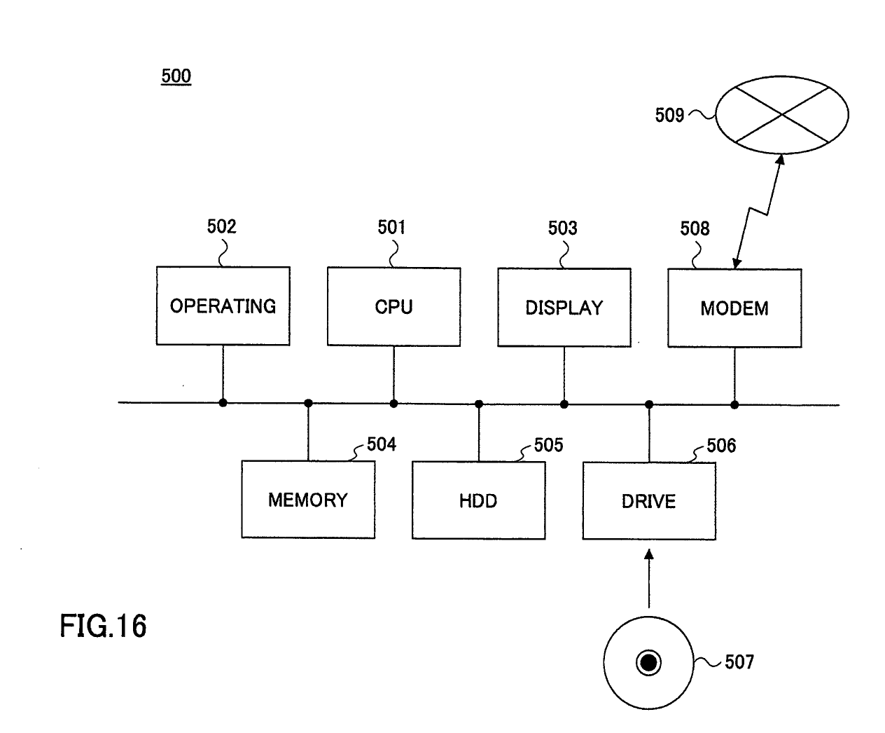

The above-mentioned net list 1, layout data 2, and parameters 3 are read by a CPU of the computer (4, in FIG. 1), and the CPU performs “grouping” (5) (see FIG. 16). That is, the computer operates according to the above-mentioned computer program, and groups FFs represented in the net list 1 and layout data 2 to obtain one or more groups of the FFs. The “optimization” may be carried out, and thus, optimum grouping may be achieved. Then, based on the groups thus obtained from the grouping, the computer carries out, in the net list 1 and layout data 2, insertion of clock buffers, and providing clock lines. Insertion of clock buffers, and providing clock lines will be described later with reference to FIG. 14. Then, a net list 7 and a layout data 8, on which the insertion of clock buffers, and providing clock lines are thus carried out, are written in a storage unit by the CPU (6). Further, in this case, “group data” 9 indicating the result of the “grouping” is also written in the storage unit by the CPU. The designer may edit the result of the “grouping” manually with reference to the group data 9.

The group data thus edited by the designer may be input to the computer. Then, the CPU of the computer reads (4) the thus-edited group data, and based on the edited group data, insertion of clock buffers, and providing clock lines may be carried out. Also in this case, the net list 7 and layout data 8 thus having undergone the insertion of clock buffers, and providing clock lines may be written (6) in the storage unit by the CPU.

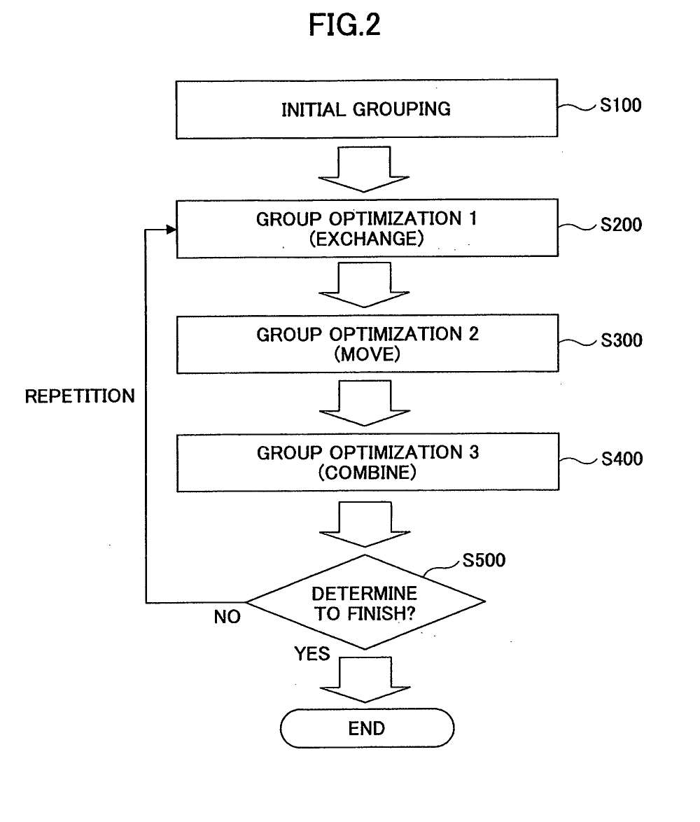

FIG. 2 illustrates a general flow of an algorithm of a computer program for realizing the clock signal providing circuit designing method in the embodiment.

The algorithm includes an initial grouping step S100, an optimization 1 (exchange) step S200, an optimization 2 (move) step S300 and an optimization 3 (combine) step S400. After the steps S100, S200, S300 and S400 are carried out, a finish determination step S500 is carried out. In the finish determination step S500, it is determined when a certain requirement is met to finish the process of FIG. 2. When the certain requirement is not met, the above-mentioned “optimization” steps 1, 2 and 3 (steps S200, S300 and S400) may be repeated.

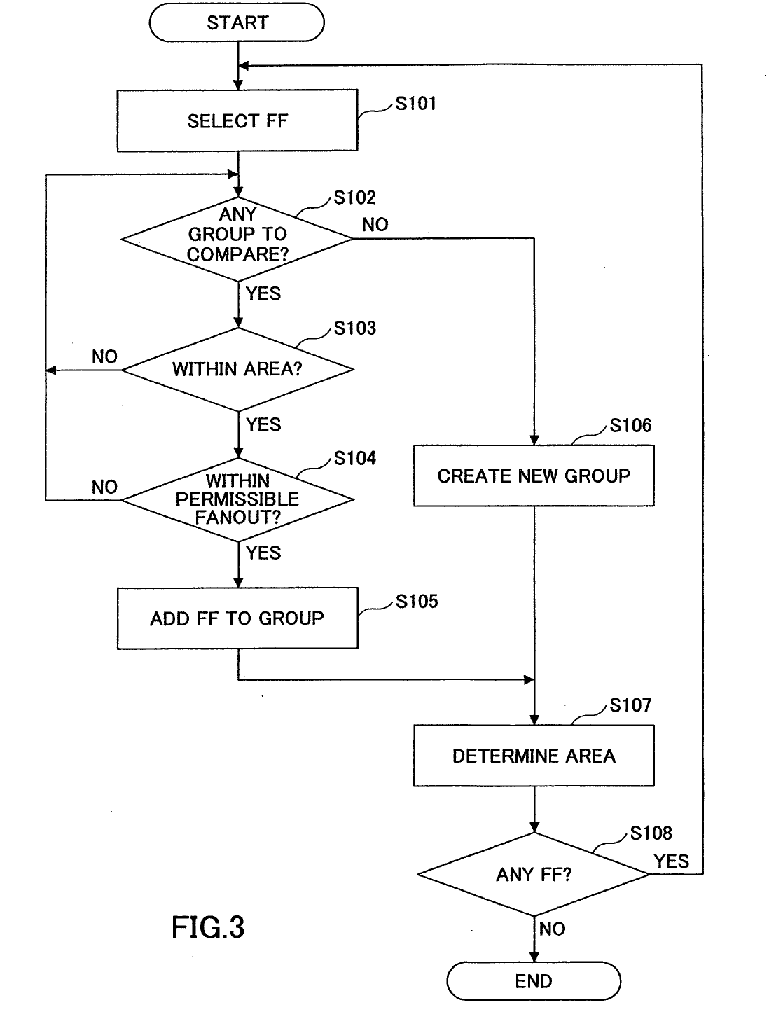

FIG. 3 illustrates details of the above-mentioned initial grouping step S100.

In FIG. 3, in step S101, a FF is selected from FFs represented in the above-mentioned net list 1 and layout data 2. A specific order of the selection is, for example, according to the net list 1.

In step S102, it is determined whether there is any “group”. Initially, there is no group (NO in step S102), and thus, step S106 is carried out. In step S106, a group for the FF is set. In step S107, based on a position of the FF (represented in the layout data 2), an area of the group is set in layout data.

Next in step S108, it is determined whether all the FFs represented in the net list 1 and layout data 2 have been selected in step S101. A case where all the FFs represented in the net list 1 and layout data 2 have been selected means a case where all the FFs belong to any groups which are set in step S106. When all the FFs represented in the net list 1 and layout data 2 have not been selected in step S101 yet; step S101 is carried out again.

Then, in step S101, another FF is selected from the FFs represented in the net list 1 and layout data 2. In step S102, it is determined whether there is any group. In this case, the group has been set as mentioned above (YES in step S102). Therefore, step S103 is carried out. It is noted that, in step S102 immediately after a new group is set in step S106, the new group is selected. Further, also in a case where, respective determination results of immediately preceding steps S103 and S104 (described later) are both YES and a FF currently processed is included in the new group in step S105 (described later), the same group is selected in the following step S102. On the other hand, in a case where, respective determination results of at least any one of immediately preceding steps S103 and S104 is NO and as a result, a FF currently processed is not included in the new group in step S105, another group is selected in the following step S102.

Next, in step S103, it is determined whether the FF selected in step S101 is located within an area of the group (which may be simply referred to as an “area”) selected in step S102, the area having been set in step S107. When the FF is located in the area, step S104 is carried out. In step S104, it is determined whether the number of FFs belonging to the group set in step S106 is within a permissible fanout included in the above-mentioned parameters 3 if the FF selected in step S101 is included in the group. When the number of FFs is within the permissible fanout if the FF selected in the immediately preceding step S101 is included in the group (YES in step S104), step S105 is carried out. In step S105, the FF selected in step S101 is included in the group in step S105. Then, in step S107, based on a position of the FFs belonging to the group, the area of the group is updated. The updating the area of the group will be described later.

Then, in step S108, as mentioned above, it is determined whether all the FFs represented in the net list 1 and layout data 2 have been selected in step S101. If not (NO in step S108), step S101 is carried out again for another FF. Thus, a loop of the steps S101, S102, S103, S104, S105, S107, S108 is repeated.

It is noted that, in step S101 during the above-mentioned repetition, a FF other than FFs which have been selected is selected. Further, an area used in step S103 is an area having undergone updating carried out in the immediately preceding step S107.

Further, in step S103 during the above-mentioned repetition, when a FF selected in the immediately preceding step S101 is not located within an area updated in the immediately preceding step S107 (NO in step S103), step S102 is carried out. In step S102, as mentioned above, another group is selected, and operation starting from S103 is carried out on the newly selected group. Similarly, when, in step S104, the number of FFs included in the group exceeds the permissible fanout if the FF selected in step S101 is included in the group (NO in step S104), step S102 is carried out. In step S102, as mentioned above, another group is selected, and operation starting from S103 is carried out on the newly selected group. However, when a new group is selected in step S102 after steps S103 and S104 being carried out for each of all the existing groups (NO in step S102), step S106 is carried out. In step S106, a new group is set for the FF selected in immediately preceding step S101, and operation starting from step S107 is carried out for the thus-set new group.

Thus, all the FFs represented in the above-mentioned net list 1 and layout data 2 belong to the respective groups set in step S106.

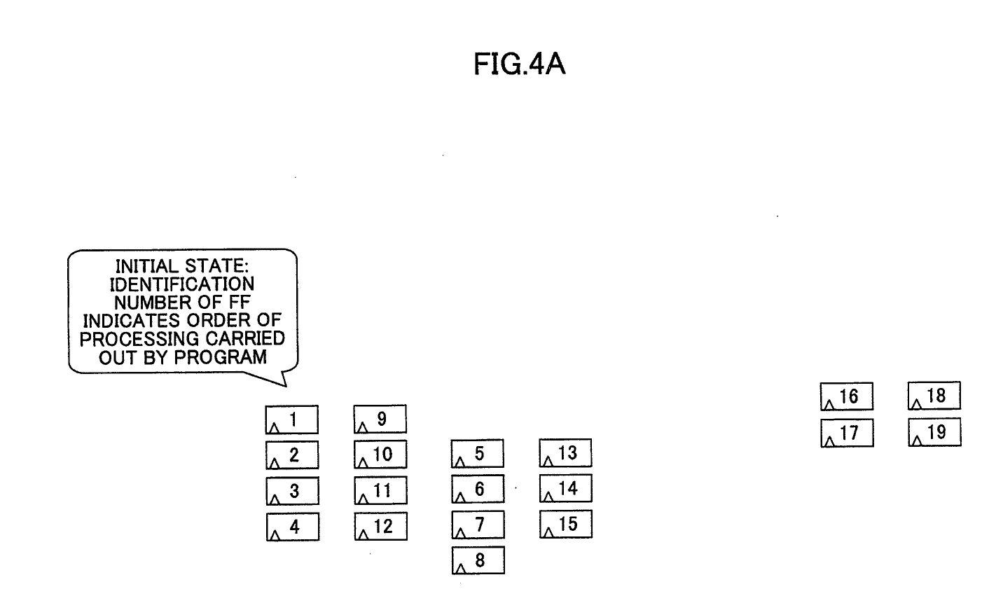

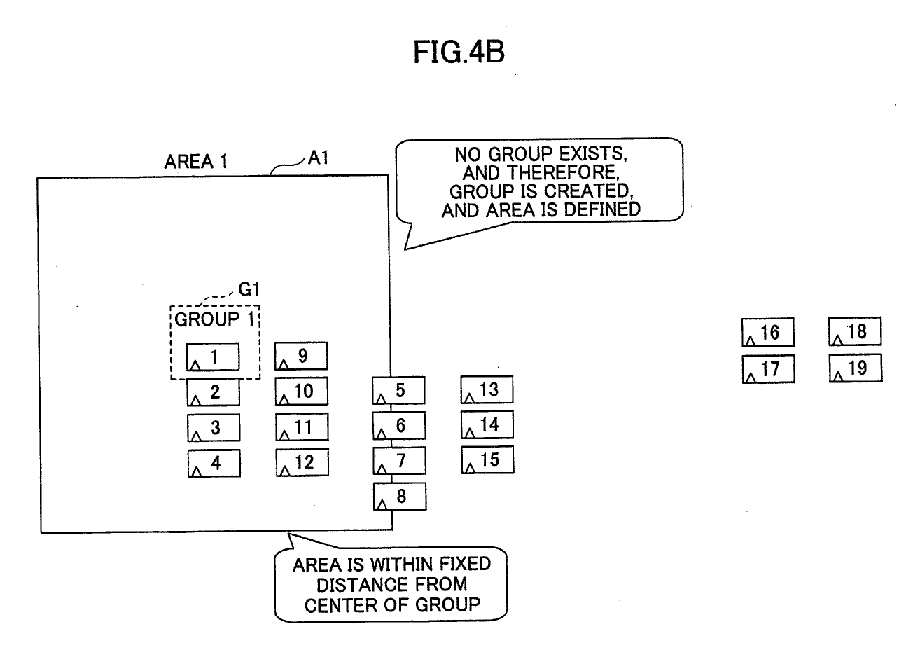

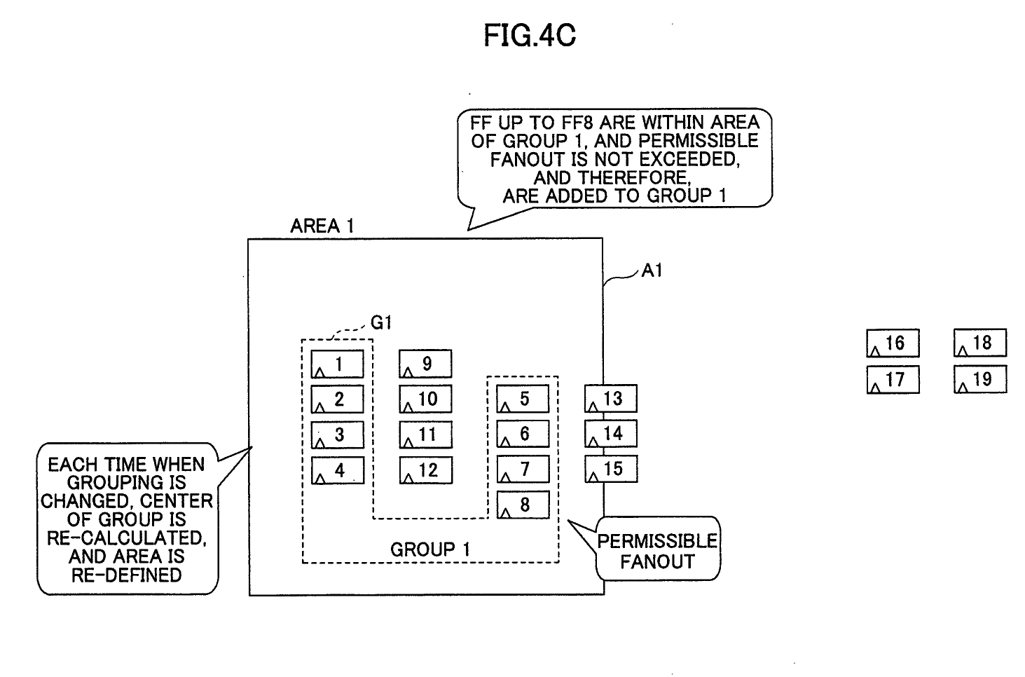

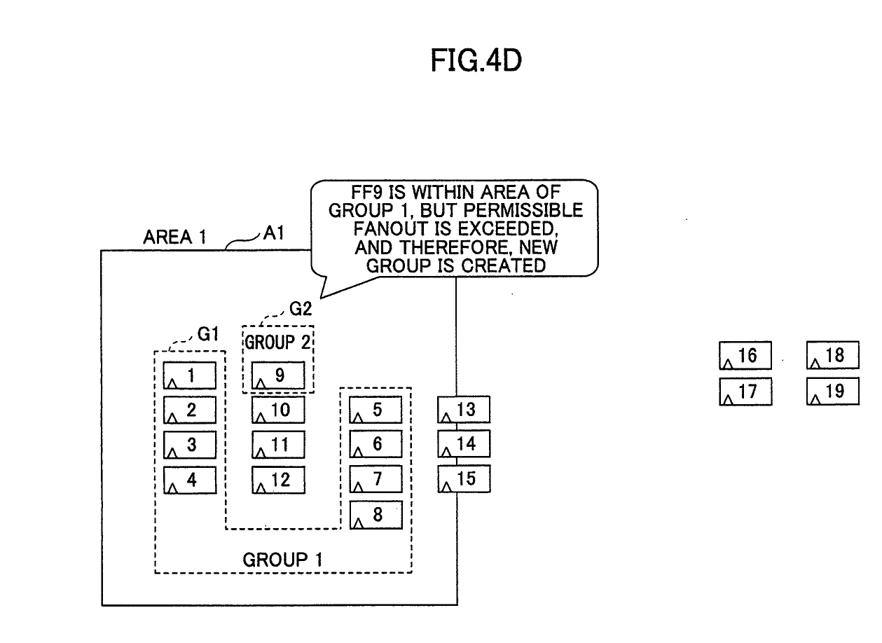

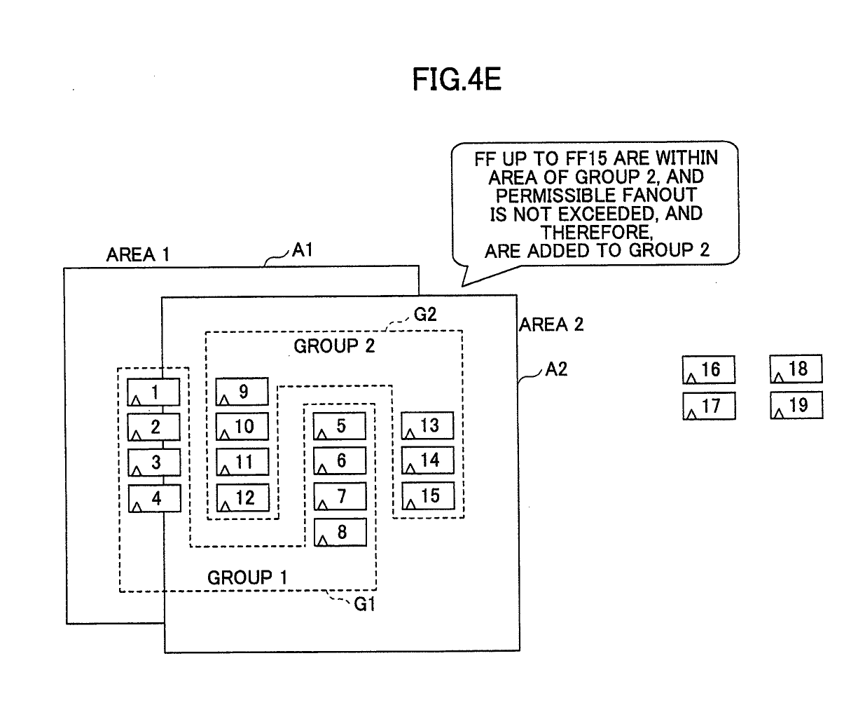

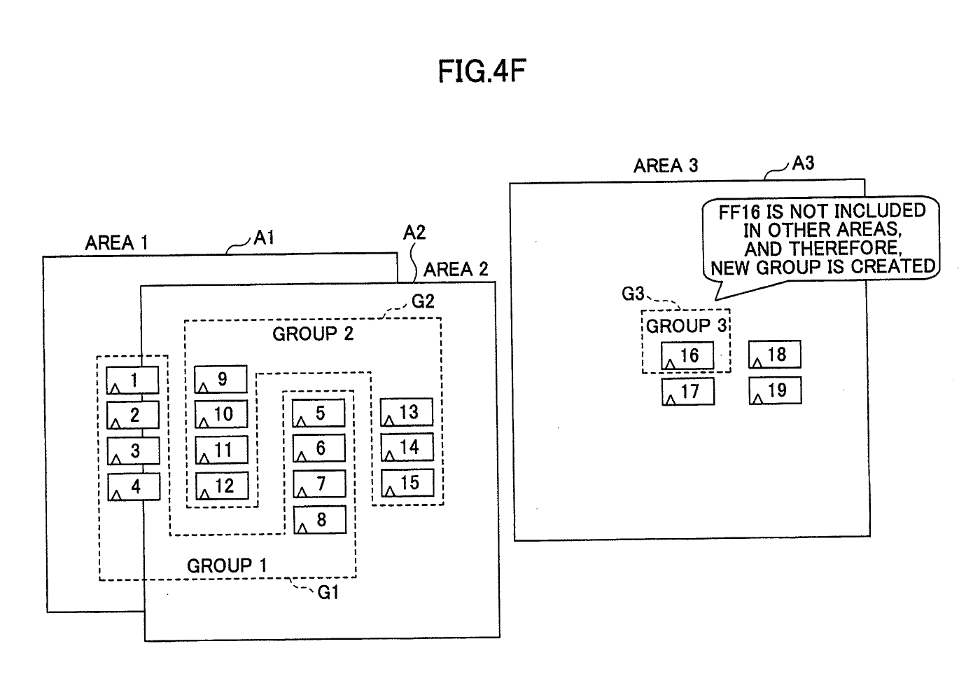

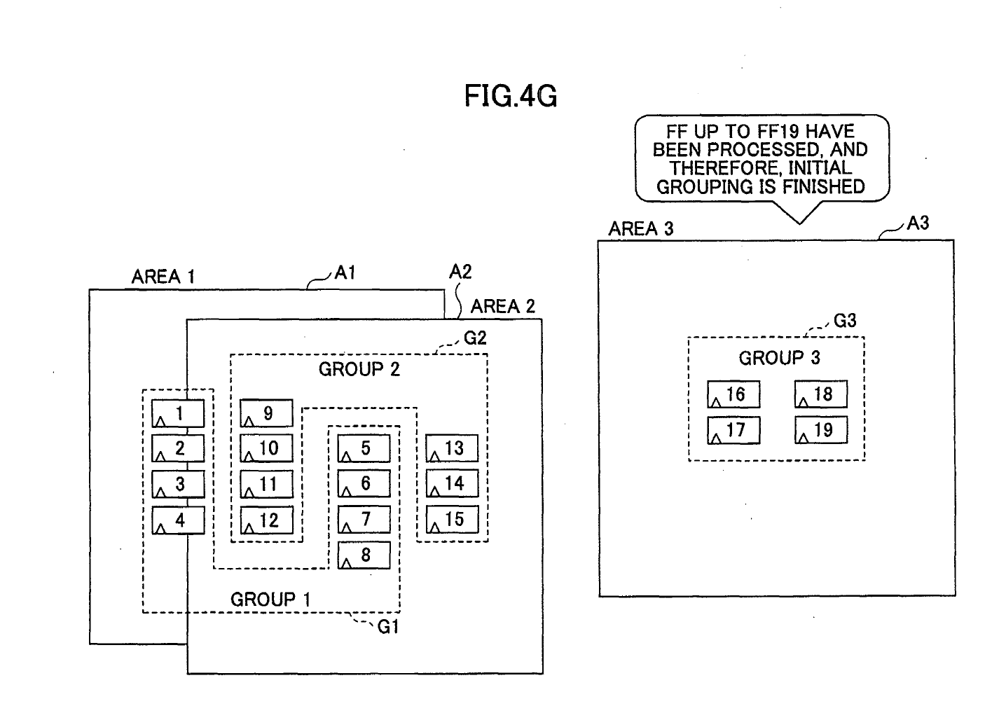

With reference to FIGS. 4A through 4G, a specific example of the initial grouping step S100 described above with reference to FIG. 3 will now be described.

In an example of FIG. 4A, as FFs represented in the net list 1 and layout data 2, there are a total of 19 FFs having identification numbers (simply referred to as No., hereinafter) of 1 through 19.

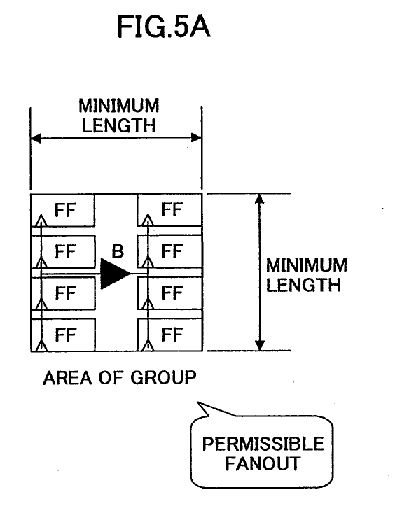

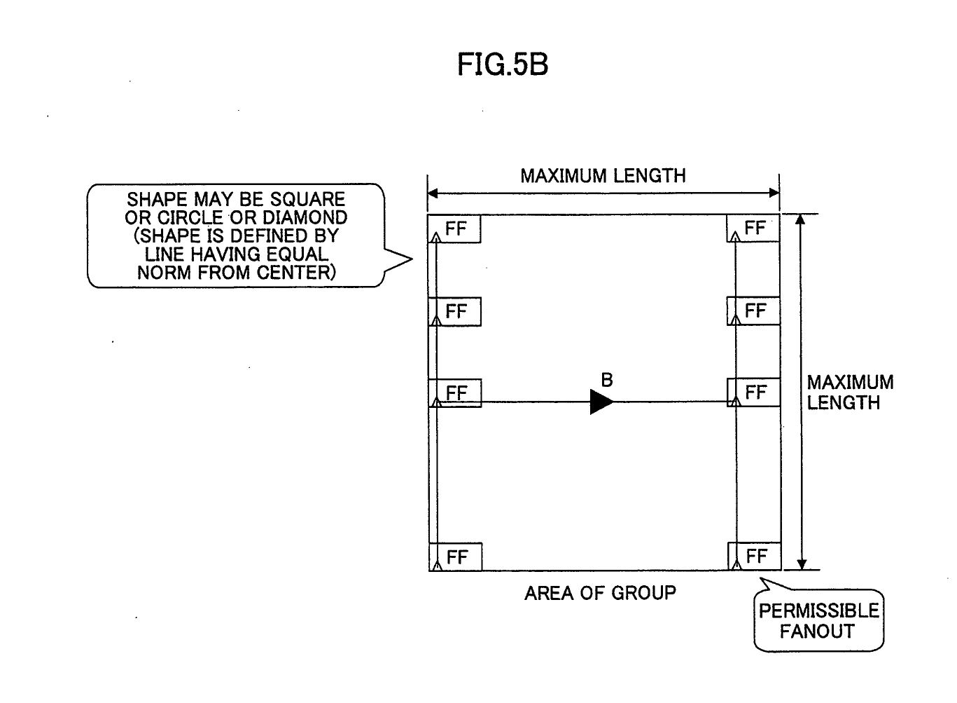

In FIG. 4B, a FF No. 1 is selected, and a group 1, G1 is set for the FF No. 1. For the group G1, an area 1, A1 is set. In this example, the area is determined as a square having a fixed size having the center which is the same as the center of the group. The center of the group has x and y coordinates each of which coordinates is obtained as the center of the maximum and minimum coordinates of each of the respective coordinates of FFs included in the group. A specific method for determining an area of a group will be described later with reference to FIGS. 5A and 5B.

FIG. 4C depicts a state in which a total of 8 FFs of No. 1 through No. 8 have been processed. It is noted that, in the example, the above-mentioned permissible fanout is set as “8”. Further, selection of a FF in step S101 of FIG. 3 is carried out in the order of the identification numbers of FFs. Further, determination as to whether a FF is located within an area of the group in step S107 of FIG. 3 is carried out such that, when only a part of the FF is included in the area, it is determined that the FF is included in the area. As a result, each of the FFs No. 1 through No. 8 meets requirements of steps S103 and S104 of FIG. 3, and are included in the group 1, G1 in step S105. As a result, as depicted in FIG. 4C, the FFs No. 1 through No. 8 belong to the group 1, G1.

The area 1, A1 is updated in step S107 each time when FFs included in the corresponding group 1, G1 increase. In the case of FIG. 4C, the 8 FFs No. 1 through No. 8 belong to the group 1, G1. As mentioned above, the area 1, A1 is updated to be a square having the fixed size having the center which is the same as the center of the corresponding group 1, G1. The area 1, A1 is updated in the case of FIG. 4C, from the area 1, A1 in the case depicted in FIG. 4B where only the FF No. 1 is included in the group 1, G1. Specifically, in the updating, the area 1, A1 is shifted rightward as depicted. Next, since all the FFs No. 1 through No. 19 have not been processed yet (YES in step S108), step S101 is carried out.

In step S101, a FF No. 9 is selected. Then, in step S102, the group 1, G1 is selected. FIG. 4D depicts a state where the FF No. 9 is thus selected. As mentioned above, the permissible fanout is 8. Since the FF No. 9 is the ninth FF for the group 1, G1 (NO in step S104), step S102 is carried out after step S104. Then, in step S102, it is determined whether there is another group. In this case, there is no other group than the group 1, G1 (NO in step S102). Therefore, step S106 is carried out. In step S106, a new group 2, G2 is set for the FF No. 9. Next, a corresponding area 2 (not depicted in FIG. 4D) is set in step S107.

FIG. 4E depicts a state in which, subsequently, FFs No. 10 through No. 15 are processed in sequence. In this state, a total of 7 FFs No. 9 through No. 15 belong to the group 2, G2. The area 2, A2 of a square having the fixed size is set for the group 2, G2. The area 2, A2 has the center the same as the center of the group 2, G2. The above-mentioned number 7 of FFs in the group 2, G2 is within the permissible fanout 8.

FIG. 4F depicts a state in which, subsequently, a FF No. 16 is processed. The FF No. 16 is not located within the area 2, A2 of the group 2, G2 (NO in step S103), and thus, step S102 is then carried out. In step S102, the group 1, G1, other than the group 2, G2, is selected. However, the FF No. 16 is not included in the area 1, A1 of the group 1, G1 (NO in step S103), and thus, step S102 is then carried out. In step S102, there is no group other than the groups 1 and 2, G1 and G2 (NO in step S102). Therefore, in step S106, a new group 3, G3 is set for the FF No. 16, and an area 3, A3, is set correspondingly in step S107. Next, in step S108, all the 19 FFs No. 1 through No. 19 have not been processed yet (YES in step S108), and thus, step S101 is carried out.

FIG. 4G depicts a state in which, subsequently, FFs No. 17 through No. 19 are processed in sequence. In this state, a total of 4 FFs No. 16 through No. 19 belong to the group 3, G3. An area 3, A3 of a square having a fixed size and having the center the same as the center of the group 3, G3 is set. The above-mentioned number 4 is within the permissible fanout 8. In this state, in step S108, all the 19 FFs No. 1 through No. 19 represented the net list 1 and layout data 2 have been already processed (NO in step S108). Thus, the initial grouping step S100 of FIG. 2 is finished.

Next, with reference to FIGS. 5A and 5B, how to determine an area of a group will be described.

As depicted in FIG. 5A, a case is assumed where clock signals are provided to FFs of a fanout of 8 by a clock buffer B. A “norm” from the center of the group is determined in such a manner that the area is larger than an area in which the FFs are disposed most densely. In this case, a minimum size of the area is obtained as a range of a thus-determined norm.

Further, as depicted in FIG. 5B, as mentioned above, a case is assumed where clock signals are provided to FFs of a fanout of 8 by a clock buffer B. In this case, a “norm” from the center of the group is determined in such a manner that the area is smaller than an area in which each of distances of the FFs from the center of the group is too long (a clock skew becomes too large). In this case, a maximum size of the area is obtained as a range of a thus-determined norm. Then, any size falling within a range between the above-mentioned minimum size and maximum size may be selected as a size of the area of the group.

Further, as mentioned above, when FFs belonging to a group change and thus the group changes, coordinates of the center of the group change accordingly. Therefore, each time the group thus changes, the area is re-calculated and is updated.

Below, examples of various “norms” which may be applied to the embodiment are depicted:
“Euclidean norm” is obtained by the following formula:

∥X∥₂:=\sqrt{|x₁|²+ . . . +|xₙ|²}

In the above formula, in a case where x1=x and x2=y, a range of the “norm” becomes a range in which a Euclidian distance is constant and thus, a range of the “norm” becomes a circular-shape range.
“Maximum norm” is obtained by the following formula:

∥X∥_{∞}:=max(|x₁|, . . . , |xₙ|)

In the above-mentioned formula, in a case where x1=x and x2=y, a range of the “norm” becomes a range in which a maximum value of each of x and y is constant and thus, a range of the “norm” becomes a square-shape range.
“p-norm” is obtained by the following formula:

$${‖ X ‖}_{p} := {( {\sum }_{i = l}^{n} {\vert {x}_{i} \vert}^{p} )}^{l / p} = \sqrt[p]{{\vert {x}_{l} \vert}^{p} + … + {\vert {x}_{n} \vert}^{p}}$$

In the above-mentioned formula, in a case where x1=x and x2=y, and further, p=1, a range of the “norm” becomes a range in which the sum total of x and y is constant and thus, a range of the norm becomes a diamond-shape range.

In cases of FIGS. 4A through 4G and the following cases, as mentioned above, the center of a group is a position which is the center between the maximum and minimum coordinates among those of all the FFs belonging to the group, in each of x and y coordinates. Then, a “norm” from the center of the group may be determined according to requirements described above with reference to FIGS. 5A and 5B. Then, an area of the group is obtained as a range of the thus-determined “norm”. In the cases of FIGS. 4A through 4G, and the following cases, the above-mentioned “Maximum norm” is applied, and thus, an area of the group is determined as a square shape having the center which is the center of the group.

Next, the above-mentioned optimization 1 (exchange) step and the optimization 2 (move) step will be described in detail.

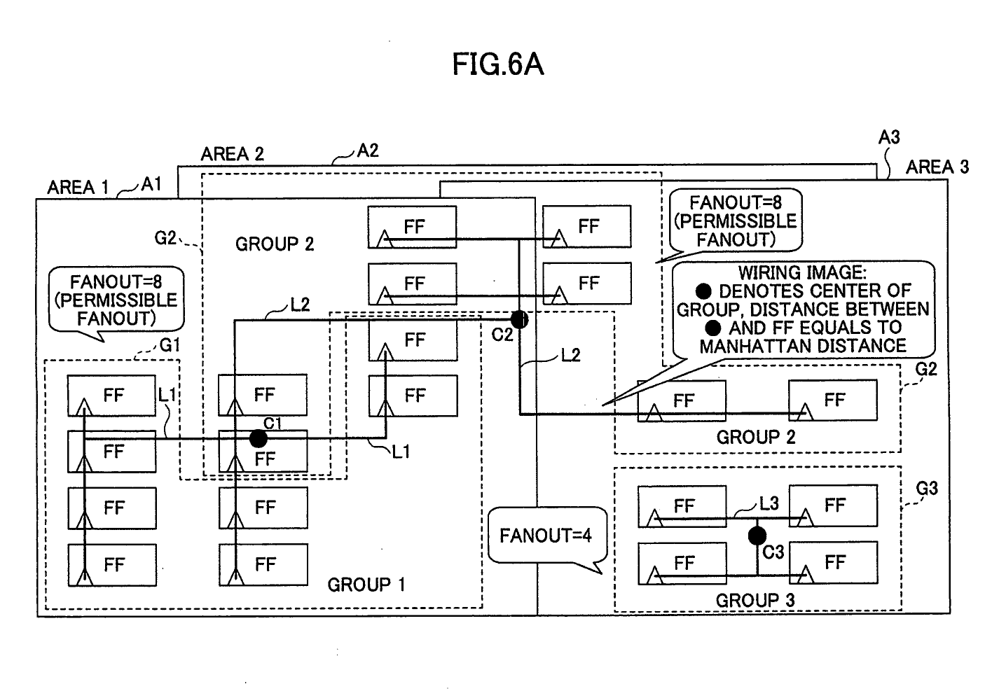

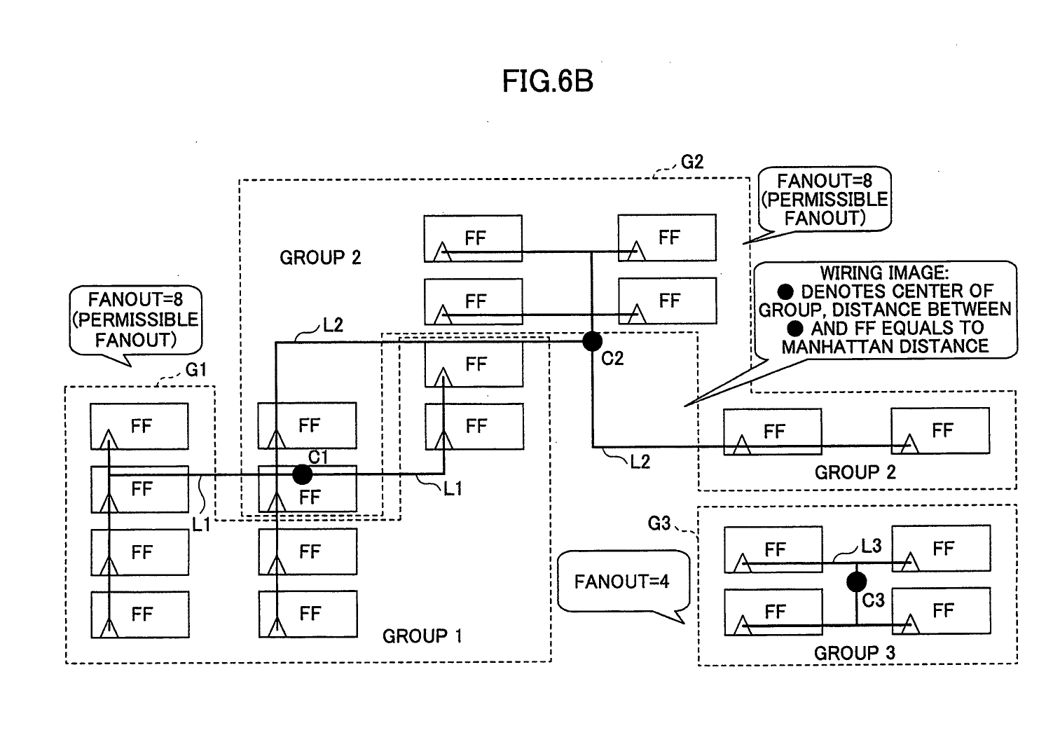

FIGS. 6A and 6B depict examples of groups obtained from the above-mentioned initial grouping S100.

As depicted in FIG. 6A, in the example, a total of 20 FFs are grouped in three groups, a group 1 through 3, G1, G2 and G3. FIG. 6A also depicts corresponding areas 1 through 3, A1, A2 and A3. In this example, as depicted in FIG. 6B, 8 FFs belong to the group 1, G1, 8 FFs belong to the group 2, G2, and 4 FFs belong to the group 3, G3. Also in this case, a permissible fanout is “8”. Further, as depicted in FIG. 6A, the areas A1, A2 and A3 overlap each other. In FIGS. 6A and 6B, C1, C2 and C3 denote the centers of the groups 1-3, G1, G2 and G3, respectively. In this case, a clock buffer is disposed at the center C1 for the 8 FFs belonging to the group 1, G1. Then, the clock buffer disposed at the center C1 provides clock signals to the 8 FFs, respectively. Similarly, a clock buffer is disposed at the center C2 for the 8 FFs belonging to the group 2, G2. Then, the clock buffer disposed at the center C2 provides clock signals to the 8 FFs, respectively. Similarly, a clock buffer is disposed at the center C3 for the 4 FFs belonging to the group 3, G3. Then, the clock buffer disposed at the center C3 provides clock signals to the 4 FFs, respectively. Clock lines L1, L2 and L3 for the groups 1-3, G1, G2 and G3, respectively, are provided in such a manner that, as depicted in FIGS. 6A and 6B, wiring lengths correspond to so-called Manhattan distances. It is noted that, a specific method for providing the clock lines are not limited to the above-mentioned method for Manhattan distances, and various methods may be applied according to a technology actually applied to the semiconductor integrated circuit represented by the net list 1 and layout data 2. The semiconductor integrated circuit represented by the net list 1 and layout data 2 may be simply referred to as a “circuit” hereinafter. It is noted that, in FIGS. 6A and 6B, for the purpose of convenience, the areas 1-3, A1-A3 are not those determined in accordance with the method for determining an area of a group described above with reference to FIGS. 5A and 5B.

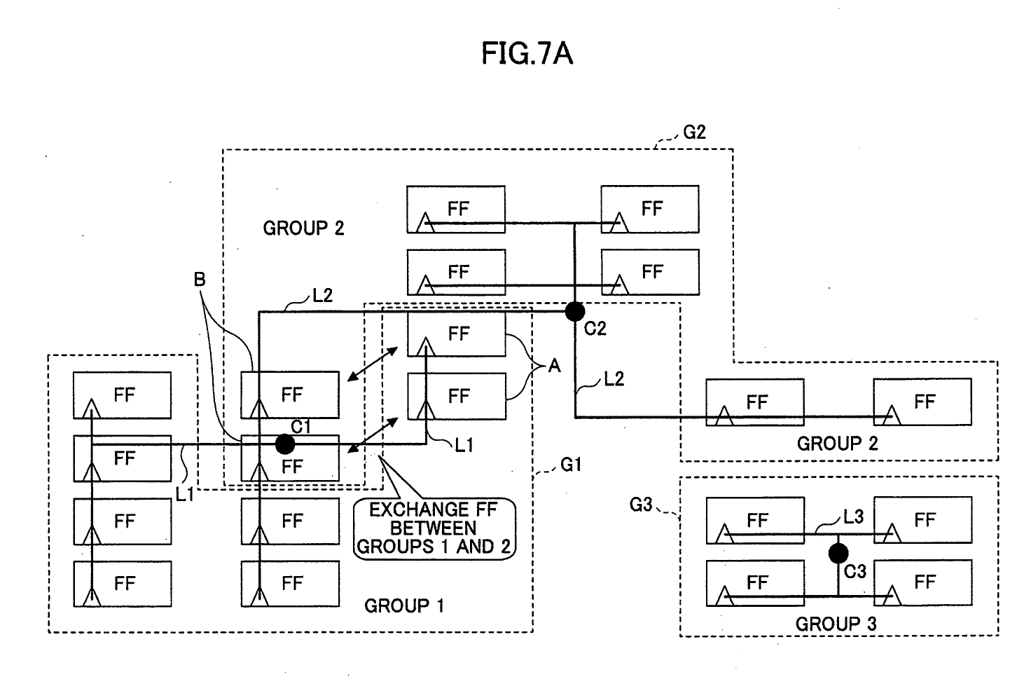

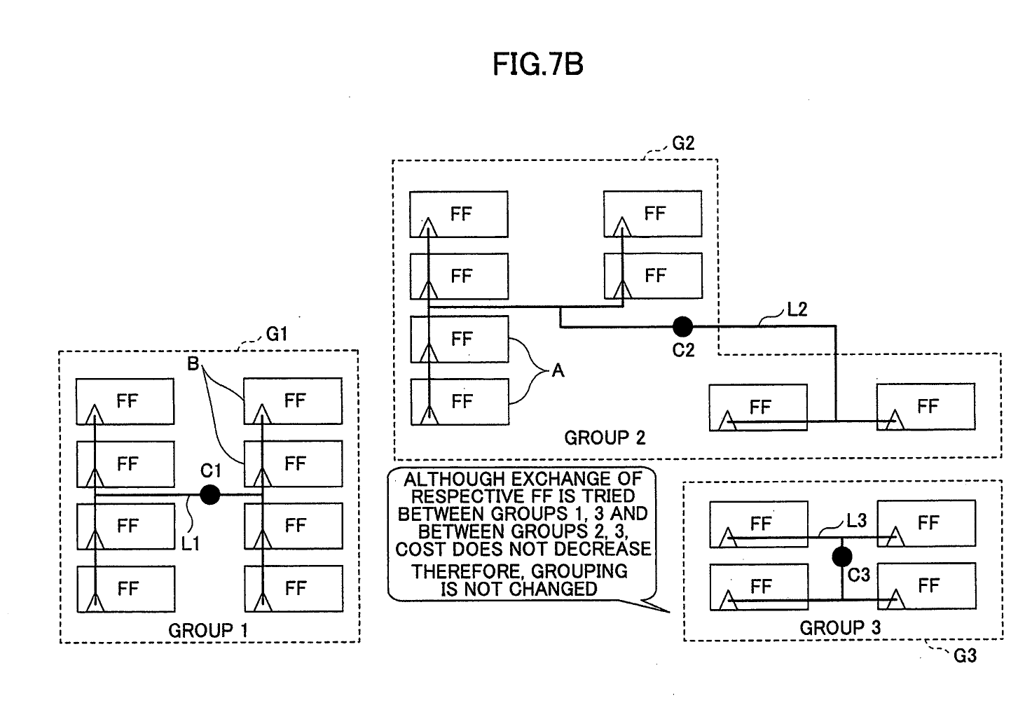

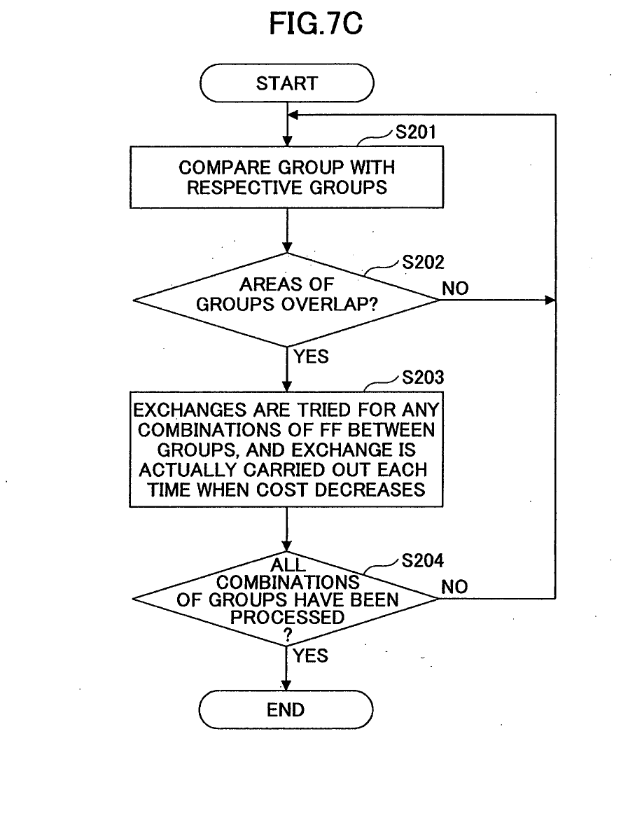

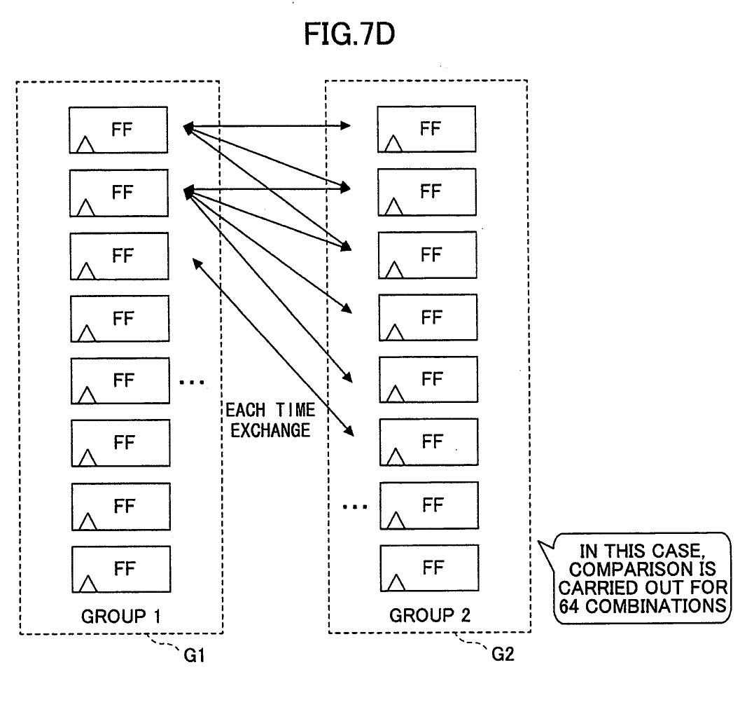

Next, an example of the optimization 1 (exchange) step carried out on the groups 1-3, G1-G3 will be described in detail with reference to FIGS. 7A through 7D.

FIG. 7A depicts a state of grouping the same as that depicted in FIG. 6A. As the optimization 1 (exchange) step S200, in FIG. 7A, two FFs A located at the top right among the 8 FFs belonging to the group 1, G1 are moved to the group 2, G2. Simultaneously, in exchange for these two FFs A, bottom left two FFs B among the 8 FFs belonging to the group 2, G2 are moved to the group 1, G1. As a result, a state depicted in FIG. 7B occurs.

Next, the states of FIGS. 7A and 7B are compared with one another for lengths of clock lines provided between clock buffers and respective FFs. In the case of FIG. 7B, the groups change from the state of FIG. 7A, and therefore, the respective centers C1, C2 and C3 of the groups 1-3, G1-G3 change accordingly. In the case of FIG. 7B, clock buffers are disposed at the centers C1-C3, respectively, of the groups 1-3, G1-G3 occurring after the above-mentioned change, and clock lines are provided for the respective FFs from the corresponding clock buffers, respectively. The clock lines L1, L2 and L3 for the groups 1-3, G1-G3 respectively, are depicted in FIG. 7B. In comparison to the clock lines L1, L2 and L3 of FIG. 7A, it can be seen that the total length of the clock lines L1-L3 is reduced in FIG. 7B through the optimization 1 (exchange) step.

FIG. 7C illustrates a flow of operation of the above-mentioned optimization 1 (exchange) step S200.

In FIG. 7C, in step S201, from groups set in the above-mentioned initial grouping S100, a combination of two groups are extracted. Alternatively, in a case of repetition of the optimization 1 (exchange) step S200, the optimization 2 (move) step S300 and the optimization 3 (combine) step S400 described later, two groups are extracted from groups occurring through preceding processing of the optimization 1 (exchange) step S200, the optimization 2 (move) step S300 and the optimization 3 (combine) step S400. Then, in step S202, it is determined whether respective areas of the thus-extracted two groups overlap one another. When the respective areas do not overlap one another (NO), step S201 is carried out, and another combination of two groups are extracted. Then, for the thus-newly-extracted two groups, step S202 is carried out.

On the other hand, when the respective areas overlap one another (YES in step S202), step S203 is carried out. In step S203, exchange of FFs is tried between the two groups. Such an operation of trying exchange of FFs between two groups may also be referred to as “provisional exchanging of FFs between two groups” or simply “provisional exchange”. Then, for a state after the provisional exchange, the sum total of Manhattan distances between the center of each group and the respective FFs belong to the group is calculated for each of all the groups. The sum total of the Manhattan distances is used as an example of a cost (or an evaluation index value) of the group (which may be simply referred to as a “cost”, hereinafter). As will be described later, an example of the cost (or evaluation index value) is not limited to the sum total of Manhattan distances. Further, costs of the respective groups are then summed up for all the groups. The sum total of the costs for all the groups will be referred to as a “whole cost”, hereinafter.

In step S203, the whole costs are compared between before and after the provisional exchange. Then when the whole cost decreases through the provisional exchange, the groups after the provisional exchanges are maintained. It is noted that, when FFs are exchanged between groups, FFs belonging to the groups are different from FFs originally belonging to the groups for FFs which are thus exchanged. Such a phenomenon that at least some of FFs of a group become different from FFs before provisional exchange will be referred to as “the group changes”. Similarly, also a phenomenon that FFs of a group reduce as a result of a FF being moved to another group will be referred to as “the group changes”. Similarly, also a phenomenon that FFs of a group increase as a result of a FF being moved to the group from another group will be referred to as “the group changes”. When a cost of a group is obtained after the group thus changes, a cost of the group is obtained after the center of the group is updated along with the group thus changes.

Returning to description of FIG. 7C, when the whole cost does not decrease through the provisional exchange (NO in step S203), the groups before the provisional exchange are maintained. Such an operation is repeated for each one of different combinations of FFs to be provisionally exchanged between the two groups. Then, each time after the provisional exchange, the groups after provisional the exchange are maintained when the whole cost decreases, while, the groups before the provisional exchange are maintained when the whole cost does not decrease.

After step S203 is finished for the two groups, it is determined in step S204 whether extraction of all possible combinations of groups has been carried out. When extraction of all possible combinations of groups has not been carried out yet (NO in step S204), step S201 is carried out. In step S201, groups in another combination are extracted. Then, for the newly extracted two groups, step S202 is carried out. When extraction of all possible combinations of groups has been carried out (YES in step S204), the optimization 1 (exchange) step is finished.

Thus, all possible combinations of groups are extracted in sequence in step S201, and steps S202 and 5203 are carried out for each of all possible combination, in sequence.

FIG. 7D illustrates a method for trying the above-mentioned optimization 1 (exchange) 5200 step to provisionally exchange FFs between the groups 1-2, G1-G2 of the example of FIG. 7A. As mentioned above, in the example of FIG. 7A, to each of the groups 1-2, G1-G2, 8 FFs belong, the number of which is equal to the permissible fanout “8”. Therefore, the number of all possible combinations of FFs for which exchange may be tried is, 8×8=64. The above-mentioned provisional exchange is carried out for the 64 combinations of FFs in sequence, and, each time after the provisional exchange, whole costs are compared between before and after the provisional exchange, after the center of each group is updated. Then, when the whole cost decreases, the groups after the provisional exchange is maintained, while, when the whole cost does not decrease, the groups before the provisional exchange is maintained. A result obtained from the above-mentioned 64 combinations of FFs being thus processed will now be described.

That is, as mentioned above, when the FFs A and B are exchanged between the groups 1-2, G1-G2 as mentioned above, a whole cost decreases. On the other hand, a whole cost does not decrease when exchange of FFs is carried out each of between the groups 1-3, G1-G3 and between the groups 2-3, G2-G3. Thus, as a result of the optimization 1 (exchange) step S200 described above with reference to FIG. 7C being carried out on the example of FIG. 7A, groups depicted in FIG. 7B is obtained in which only the exchange of the FFs A and B between the groups 1-2, G1-G2 is carried out.

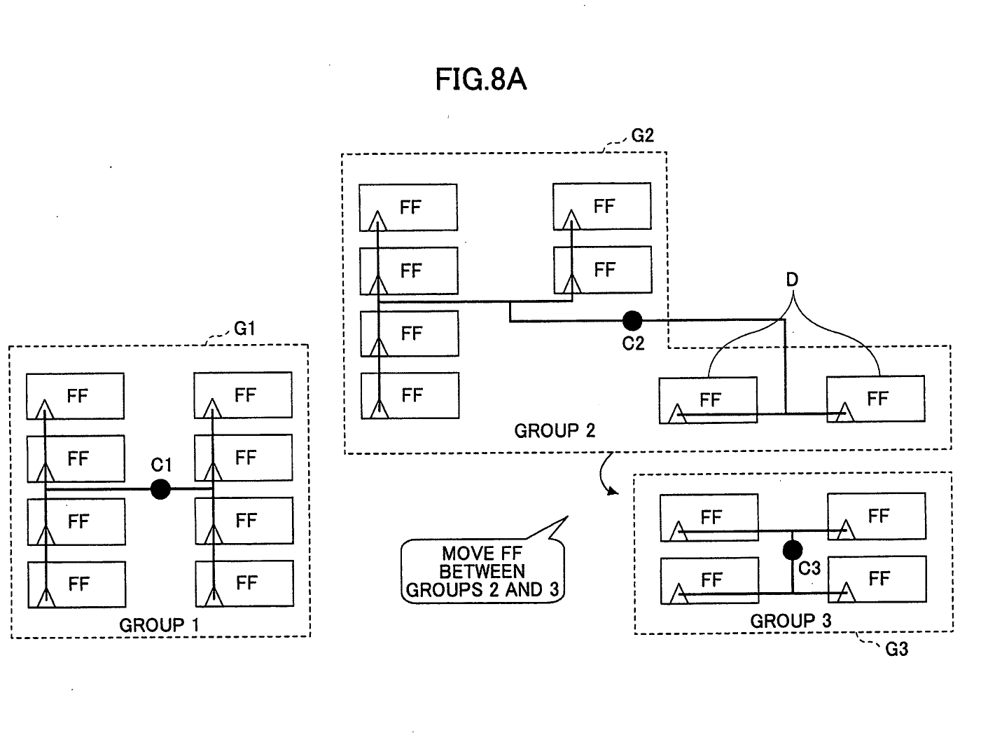

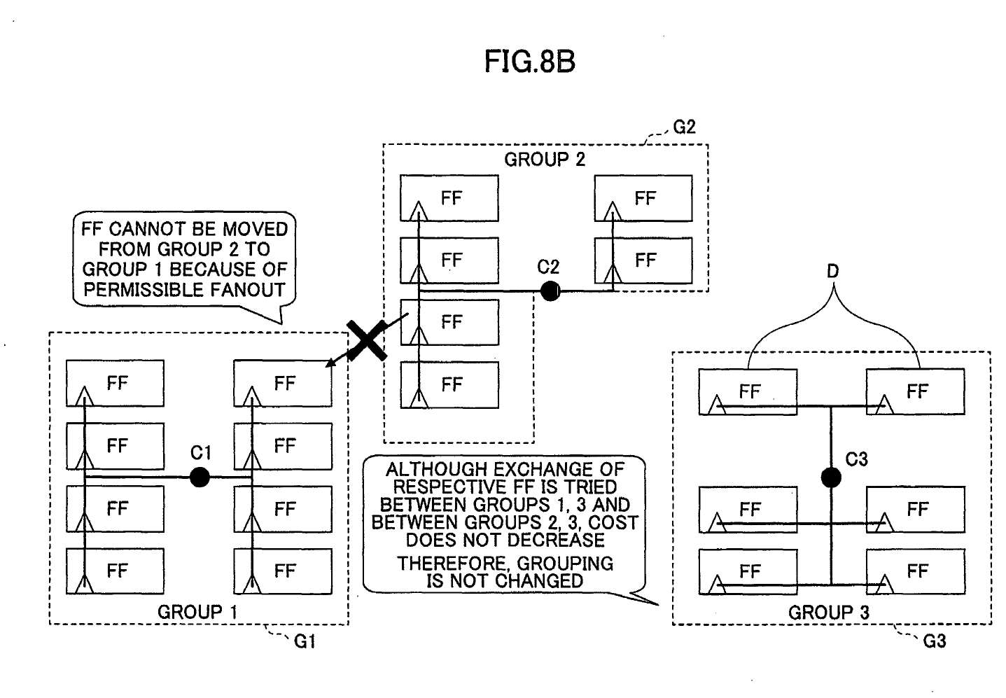

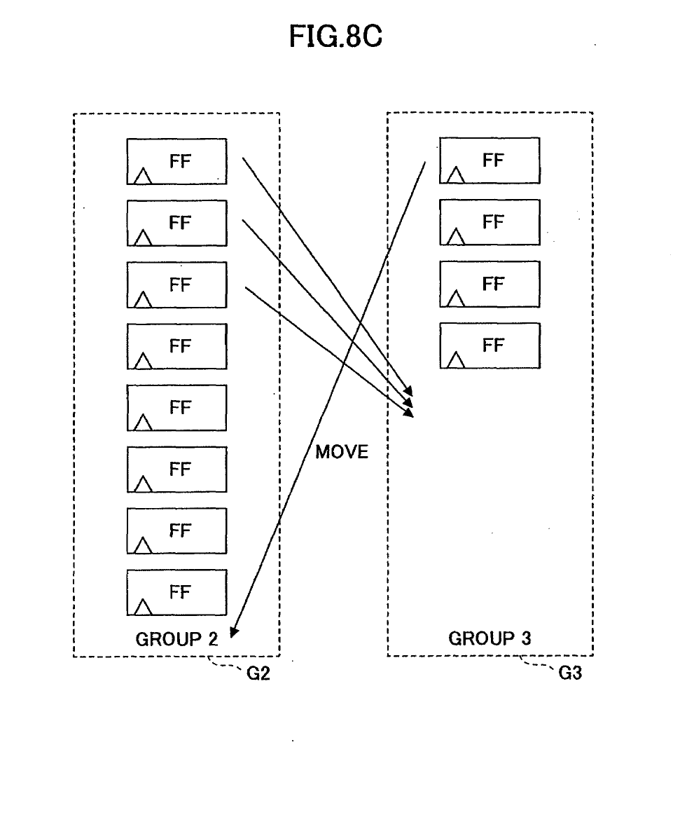

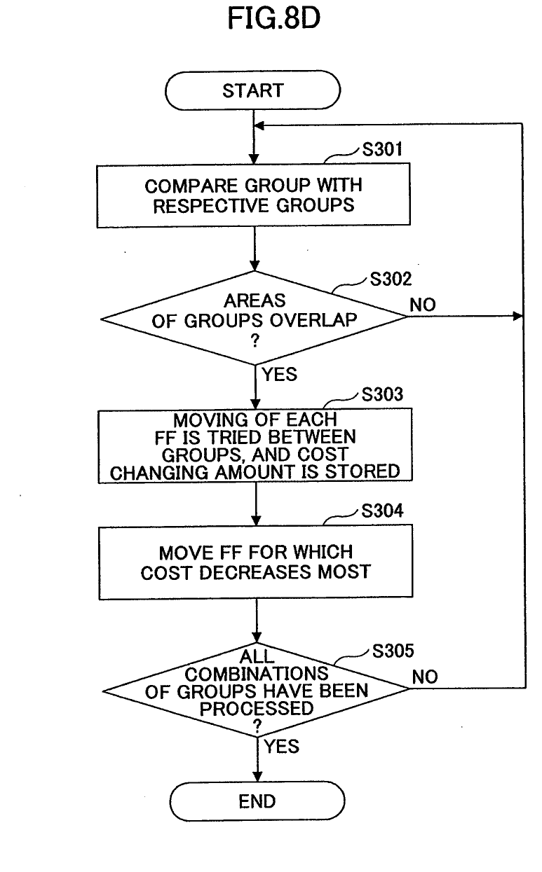

Next, with reference to FIGS. 8A-8D, the optimization 2 (move) 5300 step will be described in detail.

FIG. 8A depicts a state of FIG. 7B, in which, the above-mentioned optimization 1 (exchange) step has been carried out on the state of FIG. 7A. It is noted that, in the state of FIG. 8A, respective areas of groups 1, 2 and 3, G1, G2 and G3 overlap each other. In this case, for example, as depicted in FIG. 8B, a whole cost decreases the most, when any one of two FFs D belonging to the group 2, G2 is moved to the group 3, G3. That is, all possible cases of moving of a FF between groups of FIG. 8A are tried in sequence, and a changing amount of a whole cost obtained after the center of each group is updated is stored in a storage unit for each case of moving of a FF between the groups of FIG. 8A. The above-mentioned trying all possible cases of moving of a FF between groups may be also referred to as “provisionally carrying out all possible cases of moving of a FF between groups” or simply “provisional moving”. From among the thus stored changing amounts of the whole cost for the respective cases of the provisional moving of all possible cases of moving of a FF between groups, a case of the largest decreasing amount in the changing amount of the whole cost is obtained. Then, the moving of a FF between groups in the case of the largest decreasing amount is effectively carried out. In a case of FIGS. 8A-8B, moving of a FF of the above-mentioned two FFs D corresponds to the above-mentioned case of the largest decreasing amount. As described above with reference to FIG. 2, the optimization (exchange) step S200, the optimization 2 (move) step S300 and the optimization 3 (combine) step S400 may be repeated when a result of the finish determination 5500 indicates to do so. In the case of FIGS. 8A-8B, the optimization (exchange) step S200, the optimization 2 (move) step S300 and the optimization 3 (combine) step S400 have been repeated. This means that the optimization 2 (move) step is carried out two times. As mentioned above, in the first time of the optimization 2 (move) step of the above-mentioned two times of the optimization 2 (move) step, moving of a FF of the above-mentioned two FFs D corresponds to the above-mentioned case of the largest decreasing amount. Further, in the second time of the optimization 2 (move) step of the above-mentioned two times of the optimization 2 (move) step, moving of the other one FF of the above-mentioned two FFs D corresponds to the above-mentioned case of the largest decreasing amount. As a result, in each of the above-mentioned two times of the optimization 2 (move) step, moving of each of the above-mentioned two FFs D corresponds to the above-mentioned case of the largest decreasing amount, and therefore, the moving is effectively carried out in each of the above-mentioned two times of the optimization 2 (move) step.

On the other hand, when, as depicted in FIG. 8B, a FF is moved from the group 2, G2 to the group 1, G1, the number of FFs belonging to the group 1, G1 becomes 9, which exceeds the permissible fanout of “8”, since the number of FFs originally belonging to the group 1, G1 is 8, which is equal to the permissible fanout of “8”. Therefore, such moving to move a FF from the group 2, G2 to the group 1, G1 is not actually carried out.

FIG. 8C illustrates a method for carrying out the optimization 2 (move) step between the groups 2 and 3, G2 and G3 as mentioned above. In the case of FIG. 8A, a total of 8 FFs belong to the group 2, G2, and a total of 4 FFs belong to the group 3, G3. In this case, for each of the 8 FFs belonging to the group 2, G2, moving to the group 3, G3 is tried, a whole cost is obtained after the center of each group is updated, and a changing amount of the whole cost is stored in the storage unit. On the other hand, if a FF belonging to the group 3, G3 is moved to the group 2, G2, the number of FFs belonging to the group 2, G2 becomes 9, which exceeds the permissible fanout “8”. Therefore, moving of a FF to the group 2, G2 from the group 3, G3 is not actually carried out. Then, a thus-stored changing amount of whole cost for each case of moving of a FF is compared with each other, moving of a FF only in a case of the largest decreasing amount is effectively carried out, and moving in any other case is not effectively carried out.

FIG. 8D illustrates a flow of operation in the optimization 2 (move) step S300.

In FIG. 8D, in step S301, a combination of two groups are extracted from groups occurring through the above-mentioned optimization 1 (exchange) step. In step S302, it is determined whether respective areas of the thus-extracted two groups overlap one another. When the respective areas do not overlap each other (NO), step S301 is carried out. In step S301, another combination of two groups are newly extracted, and step S302 is carried out on the newly extracted two groups.

On the other hand, when the respective areas overlap each other in step S302 (YES), step S303 is carried out. In step S303, moving of each FF is tried between these two groups. To try moving of a FF may also be referred to as “provisional moving”. Then, for a state after the provisional moving, a whole cost is obtained after the center of each group is updated. Then, whole costs are compared between before and after the provisional moving, and a changing amount in the whole costs is obtained, and is stored in the storage unit each time of provisional moving. Such an operation is repetitively carried out for each FF of the two groups, and a changing amount in the whole cost is stored in the storage device each time of such provisional moving. It is noted that, as mentioned above, when the number of FFs belonging to at least one of the two groups has reached the permissible fanout in such provisional moving, the provisional moving is not effectively carried out. Then, in step S304, the thus-stored changing amount in the whole cost for each case of provisional moving is compared with each other, provisional moving only in a case of the largest decreasing amount in the changing amount of the whole cost is made to be effective carried out, and thus, is fixed, and provisional moving in any other cases is not made to be effective, and thus, is cancelled.

After step S304 is thus finished for the two groups, it is determined in step S305 whether all of the possible combinations of two groups have been extracted in step S301. When all the possible combinations of two groups have not been extracted yet (NO), step S301 is carried out. In step S301, another combination of two groups are extracted, and step S301 is carried out on the newly extracted two groups. When all the possible combinations of two groups have been extracted (YES in step S305), the optimization 2 (move) step is finished.

Thus, all the possible combinations of two groups are extracted in sequence in step S301, and steps S303 and S304 are carried out on all the possible combinations of two groups which meet the requirement of step S302 in sequence.

As a result of the above-described optimization 2 (move) step with reference to FIG. 8D being carried out on the groups of FIG. 8A, in the example, as mentioned above, one of the two FFs D belonging to the group 2, G2 is moved to the group 3, G3. Then, the optimization 1 (exchange) step S200, the optimization 2 (move) step S300 and the optimization 3 (combine) step S400 may be repeated. In the thus-repeated optimization 2 (move) step, the other one of the two FFs D belonging to the group 2, G2 is then moved to the group 3, G3. As a result, a state depicted in FIG. 8B occurs, i.e., consequently, the two FFs B of the group 2, G2 are moved to the group 3, G3. It is noted that, in this case, in the optimization 3 (combine) step, a requirement for effectively carrying out combining groups, described later, is not met, and thus, combining groups is not carried out effectively. Further, in the thus-repeated optimization 1 (exchange) step, there is no case where a whole cost decreases through provisional exchange of FFs, and provisional exchange is not made effective. Therefore, in this case, the groups do not change in the first optimization 3 (combine) step S400 and the repeated optimization 1 (exchange) S200 step between the first optimization 2 (move) step S300 and the repeated optimization 2 (move) step S300.

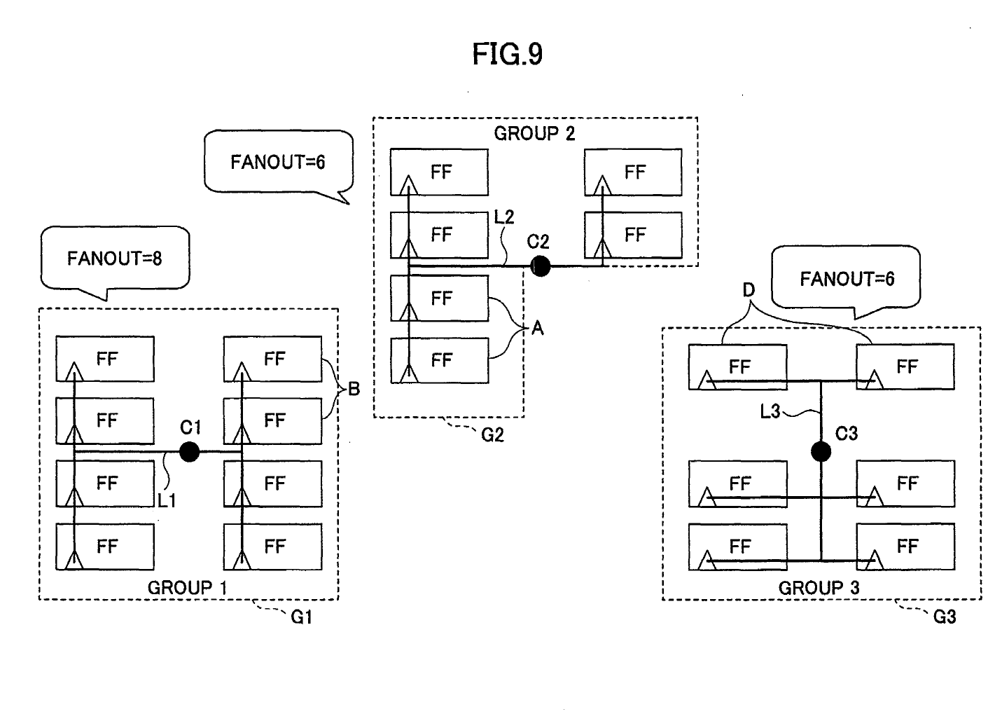

FIG. 9 depicts a state the same as the state of FIG. 8B, and illustrates advantages of the above-mentioned optimization 1 (exchange) 5200 step and the optimization 2 (move) step S300.

The state of FIG. 9 is compared with the state of FIG. 7A before the optimization 1 (exchange) step S200 and the optimization 2 (move) step S300. In the state of FIG. 7A, for example, the group 1, G1 is focused. Two FFs A belong to the group 1, G1, and 8 FFs including the two FFs A scatter horizontally as depicted in FIG. 7A. In this state, as depicted in FIG. 7A, a clock buffer may be disposed at the center C1 of the group 1, G1, and clock lines L1 may be provided from the clock buffer to the respective 8 FFs in such a manner that wiring lengths correspond to Manhattan distances, respectively. On the other hand, in the state of FIG. 9, to the group 1, G1, instead of the two FFs A, two FF B originally belonging to the group 2, G2 belong. As a result, 8 FFs including the two FFs B relatively concentrate horizontally. Also in this case, a clock buffer may be disposed at the center C1 of the group 1, G1, and clock lines L1 may be provided from the clock buffer to the respective 8 FFs in such a manner that wiring lengths correspond to Manhattan distances, respectively. In comparison between the clock lines L1 of FIG. 7A and the clock lines L1 of FIG. 9, it can be seen that the total length of the clock lines L1 of FIG. 9 is smaller than the total length of the clock lines L1 of FIG. 7A. The same discussion may also be applied to clock lines L2 of the group 2, G2.

Next, for the groups 2 and 3, G2 and G3, the states before and after the optimization 1 (exchange) step S200 and the optimization 2 (move) step S300 are compared, i.e., the states of FIG. 7A and FIG. 9 are compared. The two FFs D, belonging to the group 2, G2 before the optimization 1 (exchange) step S200 and the optimization 2 (move) step S300, belongs to the group 3, G3 after the optimization 1 (exchange) step S200 and the optimization 2 (move) S300 step. As a result, focusing the group 3, G3, the number of FFs of the group 3, G3 increases from 4 to 6, and thereby, a total length of clock lines L3 increase, accordingly. However, simultaneously, focusing the group 2, G3, in addition to the FFs B being exchanged with the FF A as mentioned above, the FFs D are moved to the group 3, G3. As a result, in the state of FIG. 9, a total of 6 FFs, belonging to the group 2, G2, relatively concentrate horizontally, and thus, a total length of clock lines L2 is remarkably smaller than that of the state of FIG. 7A. As a result, throughout all the groups 1, 2 and 3, G1, G2 and G3, the sum total of respective total lengths of clock lines L1, L2 and L3 of the state of FIG. 9 is smaller than that of the state of FIG. 7A.

As mentioned above, in the optimization 1 (exchange) S200 step, in step S203 of FIG. 7C, exchange of FFs is effectively carried out only when a whole cost decreases. Further, in the optimization 2 (move) step S300, moving of a FF is effectively carried out only for a case of the largest decreasing amount in the changing amount of a whole cost in step S304 of FIG. 8D. As a result, as described with reference to FIGS. 7A and 9, it is possible to reduce the sum total of respective total lengths of clock lines throughout all the groups.

Further, when a fanout of each group is focused, respective fanouts of the groups 1, 2 and 3, G1, G2 and G3 are 8, 8 and 4 in the state of FIG. 7A. In contrast thereto, in the state of FIG. 9, respective fanouts of the groups 1-3, G1-G3 are 8, 6 and 6. In comparison to the state of FIG. 7A in which a maximum difference between the respective fanouts is 4 between 8 and 4, a maximum difference between the respective fanouts in the state of FIG. 9 is 2 between 8 and 6. Thus, a variation in the fanouts can be reduced.

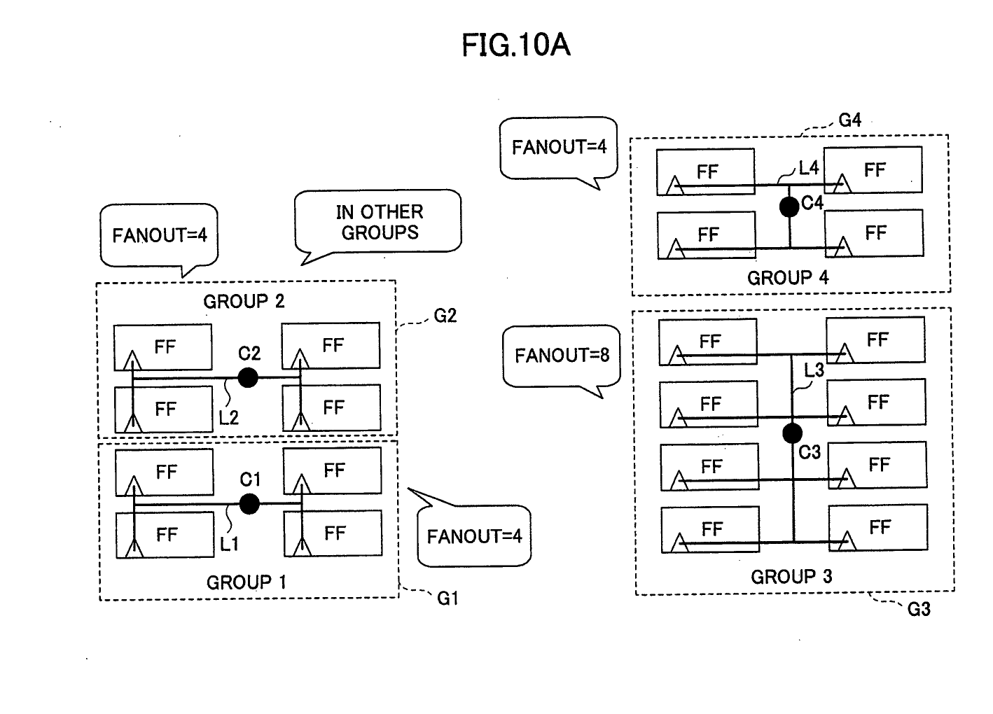

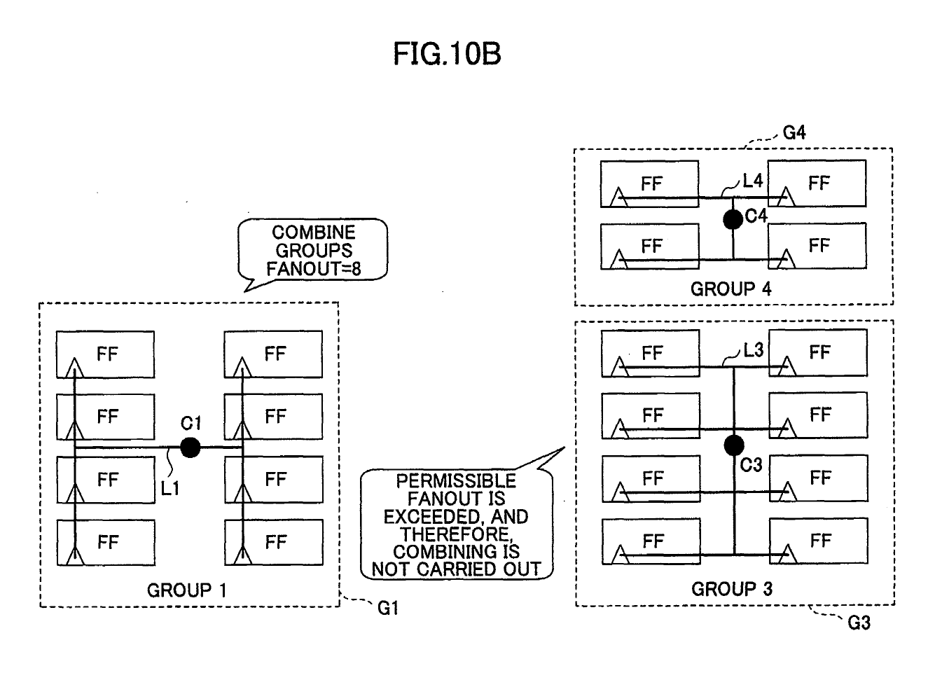

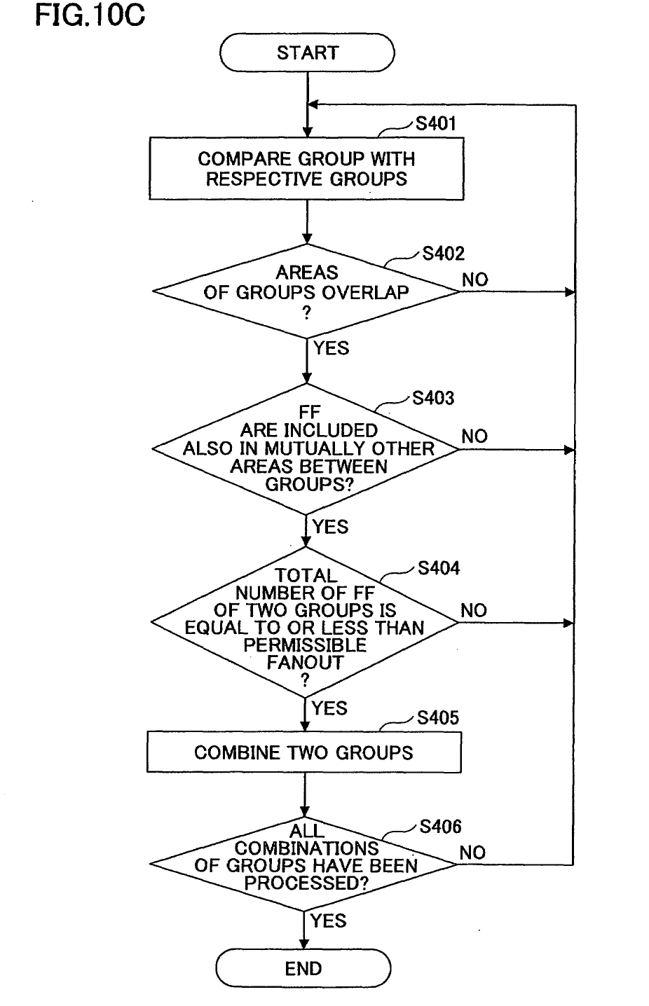

The above-mentioned optimization 3 (combine) step S400 will now be described in detail, with reference to FIGS. 10A through 10C.

FIG. 10A depicts an example of groups occurring through the above-mentioned optimization 2 (move) step S300. In this example, a total of 20 FFs are included in a circuit. 4 FFs belong to a group 1, G1, 4 FFs belong to a group 2, G2, 8 FFs belong to a group 3, G3, and 4 FFs belong to a group 4, G4, as depicted in FIG. 10A. Further, in this case, between the groups 1 and 2, G1 and G2, FFs belonging to each group are located also in an area of another group. That is, the 4 FFs belonging to the group 1, G1 are located also within an area (not depicted) of the group 2, G2. Similarly, the 4 FFs belonging to the group 2, G2 are located also within an area (not depicted) of the group 1, G1. Such a relationship holds also between the groups 3 and 4, G3 and G4. That is, the 8 FFs belonging to the group 3, G3 are located also within an area (not depicted) of the group 4, G4. Similarly, the 4 FFs belonging to the group 4, G4 are located also within an area (not depicted) of the group 3, G3.

When two groups thus have such a relationship that all the FFs belonging to a first one of the two group are located also within an area of a second one of the two group, and also, all the FFs belonging to the second one of the two group are located also within an area of the first one of the two group, the relationship is referred to as a “relationship of FFs being included in mutually other areas”.

In the optimization 3 (combine) step S400, the following operation is carried out each of between the groups 1-2, G1-G2 and between the groups 3-4, G3-G4, having the relationship of FFs being included in mutually other areas. First, respective fanouts of two groups are summed up and, when the thus-obtained sum total of the fanouts is within the permissible fanout, the two groups are combined together, so that the two groups change into a single group. As mentioned above, when a clock signal is provided for each FF, a single clock buffer is provided for each group. As a result of two groups being combined together as mentioned above, the number of groups set for the circuit is reduced accordingly. As a result, throughout the circuit, the required number of clock buffers is reduced accordingly. Thus, it is possible to reduce power consumption accordingly.

In the case of FIG. 10A, first, between the groups 1-2, G1-G2, as mentioned above, the number of FFs belonging to each group is 4, and thus, the fanout of each group is 4. Therefore, the sum total of the respective fanouts is 8 (=4+4), which is within the above-mentioned permissible fanout 8. Therefore, the requirements for combining the groups are met, and the two groups 1-2, G1-G2 are actually combined together, as depicted in FIG. 10B. On the other hand, between the groups 3-4, G3-G4, as mentioned above, the numbers of FFs belonging to the respective groups are 8 and 4, and thus, the fanouts of the respective groups are 8 and 4. Therefore, the sum total of the respective fanouts is 12 (=8+4), which exceeds the permissible fanout 8. Therefore, the requirements for combining the two groups are not met, and the two groups 3-4, G3-G4 are not actually combined together, as depicted in FIG. 10B.

FIG. 10C illustrates a flow of operation in the optimization 3 (combine) step.

In FIG. 10C, in step S401, a combination of two groups are extracted from groups occurring through the above-mentioned optimization 2 (move) step. In step S402, it is determined whether respective areas of the two groups overlap one another. When the respective areas overlap one another (YES), step S403 is carried out. In step S403, it is determined whether the two groups have a relationship of FFs being included in mutually other areas. When the two groups does not have the relationship (NO in step S403), step S401 is carried out. In step S401, another combination of two groups are extracted, and operation starting from step S402 is carried out on the newly extracted two groups. On the other hand, when the two groups have the relationship (YES in step S403), step S404 is carried out.

In step S404, it is determined whether the sum total of respective fanouts of the two groups falls within the permissible fanout. When the sum total does not fall within the permissible fanout (NO in step S404), step S401 is carried out. In step S401, another combination of two groups are extracted, and operation starting from step S402 is carried out on the newly extracted two groups. When the sum total of respective fanouts of the two groups falls within the permissible fanout (YES in step S404), step S405 is carried out. In step S405, the two groups are combined together into a single group. Then, in step S406, it is determined whether all possible combinations of two groups have been extracted in step S401. When all possible combinations of two groups have not been extracted yet (NO in step S406), step S401 is carried out. In step S401, another combination of two groups are extracted, and operation starting from step S402 is carried out on the newly extracted two groups. When all possible combinations of two groups have been extracted (YES in step S406), the optimization 3 (combine) 5400 step is finished.

Thus, all possible combinations of two groups are extracted in sequence in step S401, and on each of all possible combinations of two groups, operation starting from step S402 is carried out.

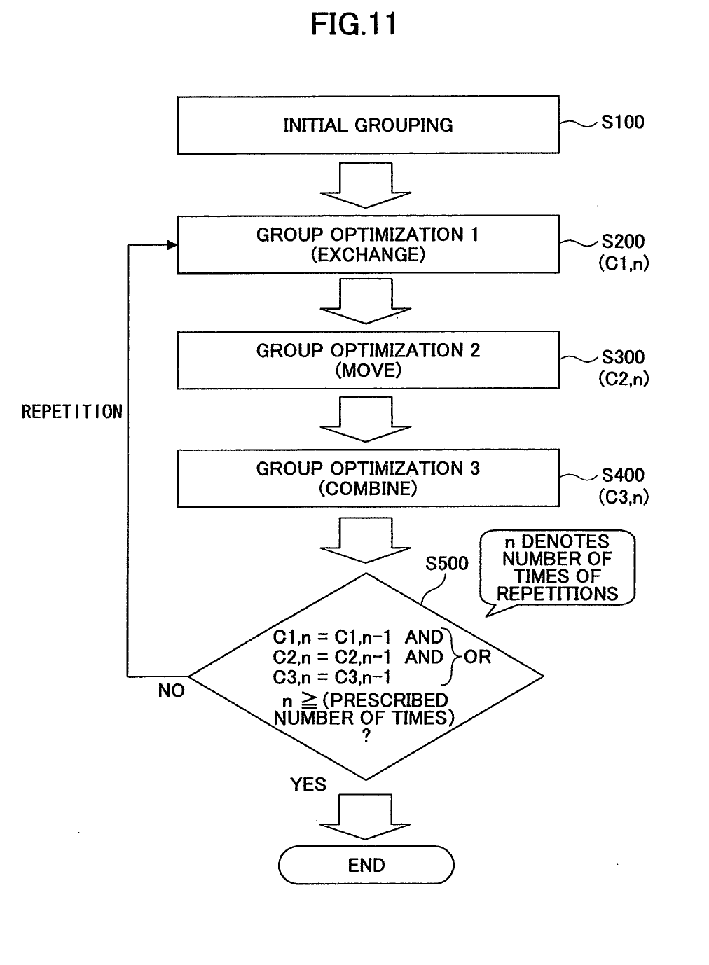

Next, with reference to FIG. 11, the finish determination S500 depicted in FIG. 2 will be described.

In the finish determination S500, when any one of the following condition 1 and condition 2 is met, it is determined that a convergence has occurred, and the optimization 1 (exchange) step S200, the optimization 2 (move) step S300 and the optimization 3 (combine) step S400 are not repeated, and a process of FIG. 2 is finished.
Condition 1: All of the following conditions 1), 2) and 3) are met:
1) A whole cost does not change and does not decrease between before and after the optimization 1 (exchange) S200 step;
2) A whole cost does not change and does not decrease between before and after the optimization 2 (move) step S300;
3) A whole cost does not change and does not decrease between before and after the optimization 3 (combine) step S400;
Condition 2: The number of times of repetitions of the optimization 1 (exchange) step S200, the optimization 2 (move) step S300 and the optimization 3 (combine) step S400 reaches a predetermined number “n”.

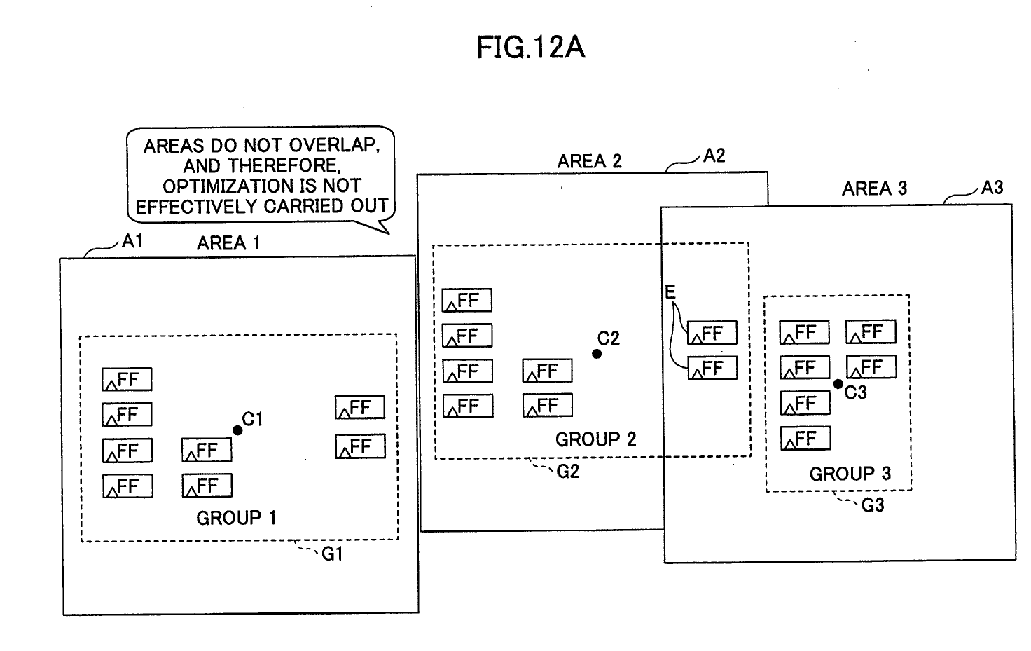

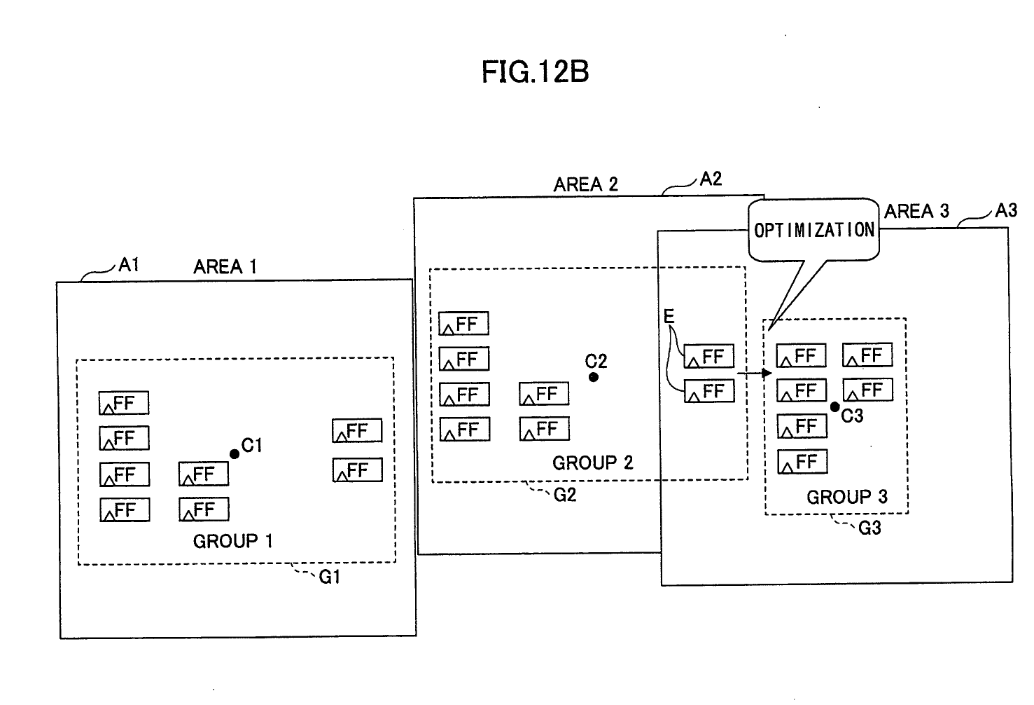

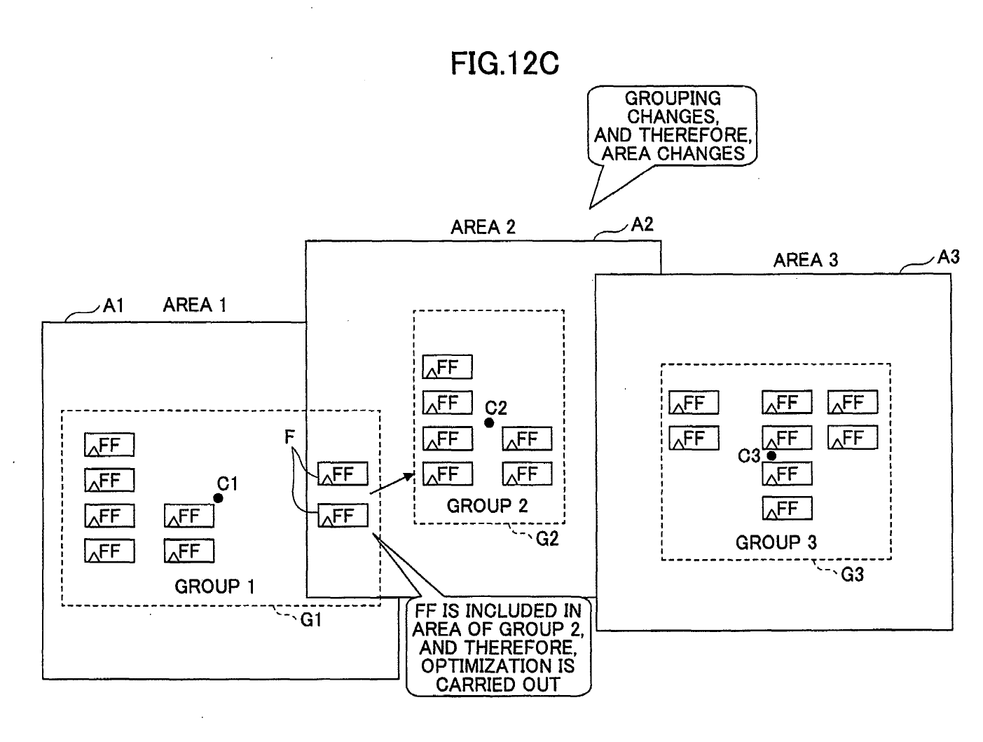

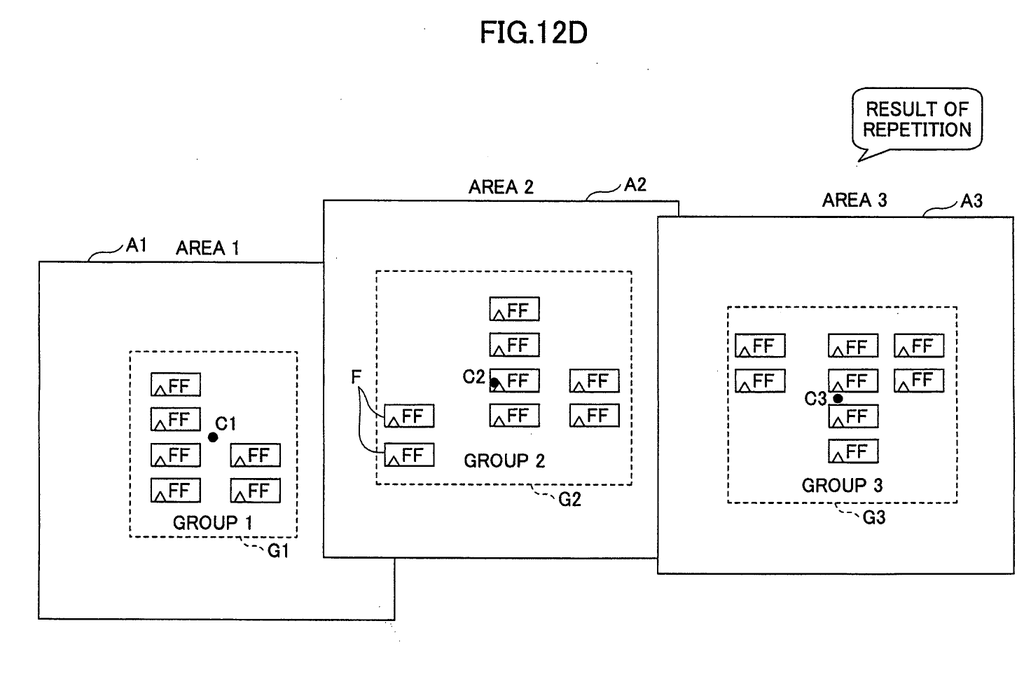

With reference to FIGS. 12A, 12B, 12C and 12D, an example of repetition of the optimization 1 (exchange) step S200, the optimization 2 (move) step S300 and optimization 3 (combine) step S400 will now be described.

FIG. 12A depicts a state in which, through the initial grouping step S100, groups 1, 2 and 3, G1, G2 and G3 are obtained. As depicted in FIG. 12A, 8 FFs belong to the group 1, G1, 8 FFs belong to the group 2, G2 and 6 FFs belong to the group 3, G3.

Each of the optimization 1 (exchange) step S200, the optimization 2 (move) step S300 and optimization 3 (combine) step S400 is carried out on groups 1 and 2, G1 and G2, on groups 1 and 3, G1 and G3, and then, on groups 2 and 3, G2 and G3, in the stated order.

In the state of FIG. 12A, respective areas 1 and 2, A1 and A2 of the groups 1 and 2, G1 and G2, do not overlap each other. Therefore, none of the optimization 1 (exchange) step S200, the optimization 2 (move) step S300 and optimization 3 (combine) step S400 is effectively carried out for the combination of the groups 1-2, G1-G2 (NO in step S202 of FIG. 7C, NO in step S302 of FIG. 8D and NO in step S402 of FIG. 10C). Similarly, respective areas 1 and 3, A1 and A3 of the groups 1 and 3, G1 and G3, do not overlap each other. Therefore, none of the optimization 1 (exchange) step S200, the optimization 2 (move) step S300 and optimization 3 (combine) step S400 is effectively carried out for the combination of the groups 1-3, G1-G3. On the other hand, respective areas 2 and 3, A2 and A3 of the groups 2 and 3, G2 and G3, overlap each other. Therefore, each of the optimization 1 (exchange) step S200, the optimization 2 (move) step S300 and optimization 3 (combine) step S400 may be effectively carried out for the combination of the groups 2-3, G2-G3 (YES in step S202 of FIG. 7C, YES in step S302 of FIG. 8D and YES in step S402 of FIG. 10C) under the condition where the other requirement is also met. Consequently, in this case, as depicted in FIG. 12B, through repetitions of the optimization 2 (move) step S300, two FFs E are moved from the group 2, G2 to the group 3, G3.

As a result of the moving of the FFs E from the group 2, G2 to the group 3, G3, as depicted in FIG. 12C, FFs belonging to the groups 2 and 3, G2 and G3, respectively, change accordingly. As a result, the respective centers C2 and C3 of the groups 2 and 3, G2 and G3 change accordingly. For example, for the group 2, G2, as mentioned above, the FFs E located at the right end are thus moved to the group 3, G3. As a result, 6 FFs are left in the group 2, G2. The center of the 6 FFs of the group 2, G2 is shifted leftward from the center of the original 8 FFs of the group 2, G2. Therefore, the center C2 of the group 2, G2 is shifted leftward accordingly. As mentioned above, the area 2, A2 of the group 2, G2 is a square having the fixed size having the center the same as the center C2 of the group 2, G2. Therefore, as a result of the shift of the center 2 leftward as mentioned above, the area 2, A2 is shifted leftward accordingly, as depicted in FIG. 12C.

As a result, as depicted in FIG. 12C, the areas 1 and 2, A1 and A2 of the groups 1 and 2, G1 and G2 come to overlap each other. In the state, different from the state of FIG. 12A mentioned above, each of the optimization 1 (exchange) S200 step, the optimization 2 (move) step S300 and optimization 3 (combine) step S400 may be effectively carried out for the combination of the groups 1-2, G1-G2 (YES in step S202 of FIG. 7C, YES in step S302 of FIG. 8D and YES in step S402 of FIG. 10C) under the condition where the other requirement is also met. As a result, in this example, as depicted in FIG. 12D, through the optimization 2 (move) step S300, a FF F of the group 1, G1 is moved to the group 2, G2.

Thus, according to the clock signal providing circuit designing method in the embodiment, when groups change through the optimization 1 (exchange) step S200, the optimization 2 (move) step S300 and optimization 3 (combine) step S400, respective areas of the groups change accordingly. As a result, two group for which respective areas thereof do not originally overlap each other may then overlap each other. In such a case, the optimization 1 (exchange) step S200, the optimization 2 (move) step S300 and optimization 3 (combine) step S400 may come to be effectively carried out on a combination of two groups, for which none of the optimization 1 (exchange) step S200, the optimization 2 (move) step S300 and optimization 3 (combine) step S400 can originally be effectively carried out. As a result, more effective optimization is expected because the number of combinations of groups on each of which the optimization 1 (exchange) step S200, the optimization 2 (move) step S300 and optimization 3 (combine) step S400 are effectively carried out may thus increase.

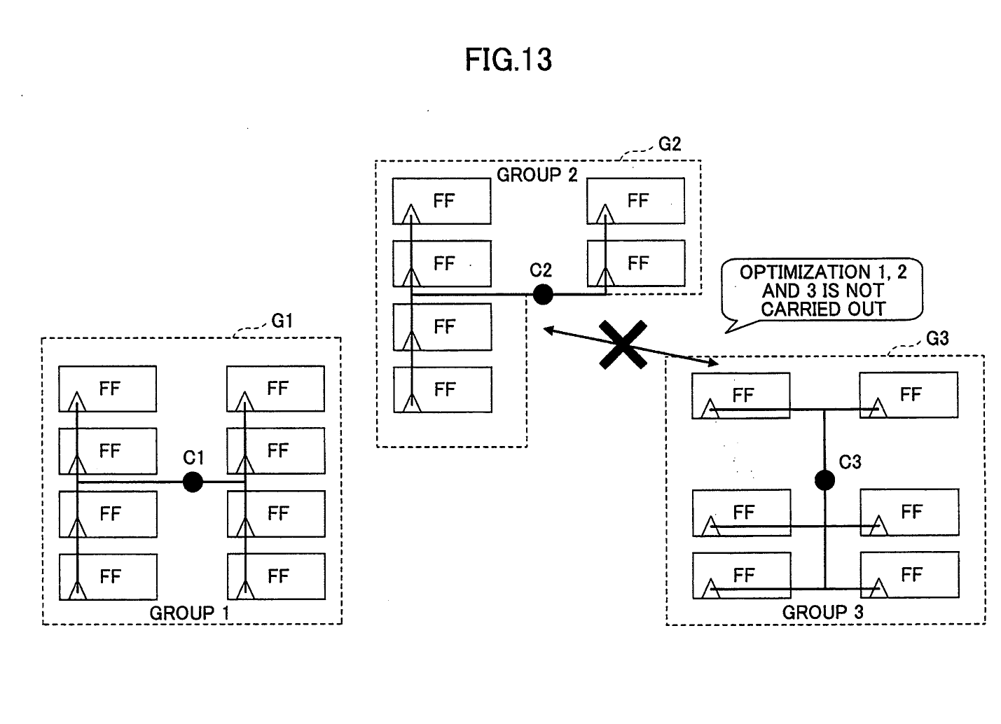

With reference to FIG. 13, additional conditions for repeating of the optimization 1 (exchange) step S200, the optimization 2 (move) step S300 and optimization 3 (combine) step S400, which may be added, will be described.

That is, there may be a case where, through the Optimization 1 (exchange) step S200, the optimization 2 (move) step S300 and optimization 3 (combine) step S400, none of exchange of FFs, moving of a FF and combining of groups are effectively carried out for a combination of two groups, and thus, the two groups do not change at all. In such a case, after that, the combination of two groups may be prevented from undergoing any one of the optimization 1 (exchange) step S200, the optimization 2 (move) step S300 and optimization 3 (combine) step S400. As a result, no processing may be carried out on the two groups after that, and thus, it may be possible to reduce the total processing amount.

With reference to FIG. 14, operation to be carried out after it is determined in step S500 of FIG. 2 that the optimization 1 (exchange) step S200, the optimization 2 (move) step S300 and optimization 3 (combine) step S400 are not carried out any more will now be described.

In the net list and layout data, clock buffers B1, B2 and B3 are inserted at the centers C1, C2 and C3 of the respective ones of the above-mentioned groups 1-3, G1-G3 (see FIG. 13), respectively. Then, from each one of the clock buffers B1-B3, a respective one of clock lines L1, L2 and L3 is provided to connect for FFs belonging to a corresponding one of the groups 1-3, G1-G3. Then, from each of the clock buffers B1-B3, a clock line L0 is connected to an end B of a nearest H tree. As a result, the FFs belonging to the respective groups 1-3, G1-G3 are connected to the end B of the H tree via the clock buffers B1-B3, respectively, in the net list and layout data.

Below, how to obtain the above-mentioned “cost” will be described.

x, y coordinates Xg, Yg of the center of a group may be obtained from the following formula:

Xg=(Xfmax+Xfmin)/2

Yg=(Yfmax+Yfmin)/2

In these formulas, Xfmax, Xfmin denote the maximum and minimum x coordinates among those of FFs belonging to the group, respectively. Similarly, Yfmax, Yfmin denote the maximum and minimum y coordinates among those of the FFs belonging to the group, respectively.

A “cost” of each group may be obtained from the following formula:

Cg=Σ(|Xf−Xg|+|Yf−Yg|)

In the formula, Xf and Yf denote x, y coordinates of each FF belonging to the group. As mentioned above, a cost of the group may be obtained as the sum total of Manhattan distances each from the center of the group to each FF. Manhattan distances correspond to wiring lengths of clock lines, and thus, in this case, the cost of the group corresponds to the total wiring length of the clock lines provided for the FFs belonging to the group.

The above-mentioned “whole cost” C may be obtained from the following formula:

C=ΣCg

In the formula, suffix “g” of Cg denotes an identification number of each group.

The above-mentioned changing amount ( [symbol] C) in the whole cost in the above-mentioned optimization 1 (exchange) step S200 and the optimization 2 (move) step S300 may be obtained from the following formula:

$$\begin{matrix} C = \{ Cia + Cja \} - \{ Cib + Cjb \} \\ = \{ \begin{matrix}Σ ( \vert Xf - Xia \vert + \vert Yf - Yia \vert ) + \\ Σ ( \vert Xf - Xja \vert + \vert Yf - Yja \vert )\end{matrix} \} - \\ \{ \begin{matrix}Σ ( \vert Xf - Xib \vert + \vert Yf - Yib \vert ) + \\ Σ ( \vert Xf - Xjb \vert + \vert Yf - Yjb \vert )\end{matrix} \}\end{matrix}$$

In the formula, each of Cia, Cja, Cib, Cjb denotes a cost.

Suffix “f” denotes an identification number of each FF.

Suffixes “i”, “j” denote identification numbers of respective groups in a combination on which provisional exchange of FFs or provisional moving of a FF is carried out.

Suffix “a” denotes after provisional exchange of FFs or provisional moving of a FF, and suffix “b” denotes before provisional exchange of FFs or provisional moving of a FF.

The above-mentioned cost Cg of each group (i.e., an evaluation index value) is not limited to the above-mentioned example using Manhattan distances (Cg=Σ(|Xf−Xg|+|Yf−Yg|)). For example, the cost Cg of each group may be any one of Cg using Euclidian distances, Cg using a total wiring length, Cg using capacitances and Cg using delays, depicted below:

1. Cg using Euclidian distances:

Cg=Σ{(Xf−Xg)+(Yf−Yg)}

2. Cg using a total wiring length:

Cg=(total wiring length)=(the sum

total of respective wiring lengths each from a clock

buffer to each FF)

3. Cg using capacitances:

Cg=(gate capacitance of clock buffer)+

(sum total of wiring capacitances each from clock

buffer to each FF)+(sum total of clock input pin

capacitances of respective FFs)

4. Cg using delays:

Cg=(sum total of delays each from clock buffer to clock input pin of each FF)

Below, processing carried out when the clock signal providing circuit designing method in the embodiment is realized by using a computer program will be generally described with reference to FIG. 1.

The net list (Verilog, VHDL or such) 1 is read by a CPU of a computer (see FIG. 16) from a storage unit, and the CPU extracts instances of FFs from the net list 1 (“read data” 4 in FIG. 1). The CPU groups the FFs to create one or more groups of the FFs (“group FF” 5). The CPU inserts a clock buffer for each of the groups in the net list and provides clock lines, as mentioned above with reference to FIG. 14. The CPU writes the net list 7 in which the clock buffers are inserted and the clock lines are provided, to the a storage unit (“write data” 6).

Similarly, as depicted in FIG. 1, the layout data (DEF, PKIT or such) 2 is read by the CPU from a storage unit, and the CPU extracts coordinates of the instances of the FFs from the layout data (“read data” 4 in FIG. 1). The CPU groups the FFs to create one or more groups of the FFs based on the extracted coordinates (“group FF” 5). The CPU inserts the clock buffer for each of the groups in the layout data and provides clock lines, as mentioned above with reference to FIG. 14. The CPU writes the layout data 8 in which the clock buffers are inserted and the clock lines are provided, to the a storage unit (“write data” 6).

It is noted that, the above-mentioned processing carried out on the net list and processing carried out on the layout data may be carried out in such manner that the resulting net list and layout data have consistency therebetween.

A designer inputs various parameters 3 to the computer in a form of a command line. The various parameters may include, as mentioned above with reference to FIG. 1, a definition of an area of a group (a method for determining an area of a group), the permissible fanout, and the above-mentioned predetermined number “n” of times of repetitions of the optimization 1 (exchange) 5200 step, the optimization 2 (move) step S300 and the optimization 3 (combine) step S400. The method for determining an area of a group is, for example, as mentioned above, to obtain an area of a square shape having a fixed size by using the Maximum norm.

The CPU writes a data file 9 storing information indicating the groups obtained from the above-mentioned process of “group FF” 5 depicted in FIG. 1. The data file 9 includes information indicating FFs belonging to each group, and may be a file of a CSV (Comma Separated Value format), for example.

The following advantages may be obtained from the clock signal providing circuit designing method in the embodiment:

1) It is possible to reduce wiring lengths of clock lines, and also, it is possible to reduce a variation in wiring lengths of the clock lines.

2) It is possible to reduce a variation in fanouts for respective clock buffers.

3) It is possible to reduce the required number of clock buffers.

4) It is possible to reduce clock skew, not locally but wholly throughout the circuit.

5) It is possible to realize the clock signal providing circuit designing method in the embodiment by using a computer program. Further, it is possible to carry out grouping FFs to create one or more groups of the FFs, within a reasonable calculation amount by using a reasonable storage capacity. That is, only combinations of two groups in each of which combinations two groups have their areas overlapping each other may undergo effective processing of the optimization steps as mentioned above. Therefore, a processing amount increases merely linearly with respect to the number of FFs included in the circuit. Further, each of exchange of FFs (the optimization 1 step S200) and moving of a FF (the optimization 2 step S300) may be effectively carried out only when a whole cost decreases. Therefore, the whole cost decreases monotonically.

Thus, according to the clock signal providing circuit designing method in the embodiment, clock skew may be reduced and the clock signal providing circuit designing method may be automated.

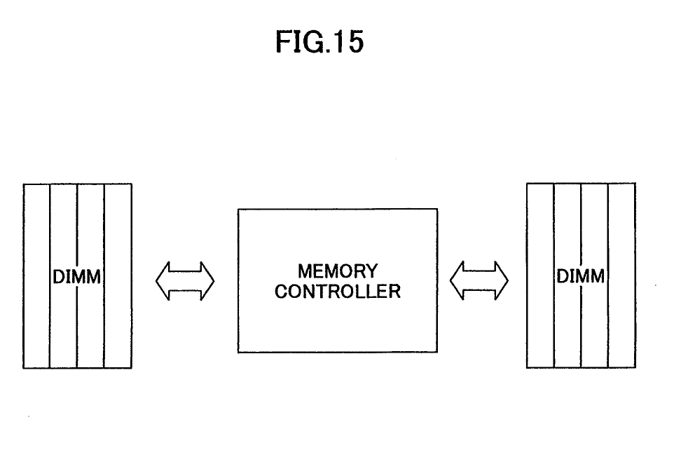

With reference to FIG. 15, an example of a semiconductor integrated circuit to which the clock signal providing circuit designing method in the embodiment was applied will now be described.

FIG. 15 depicts a memory controller controlling a DIMM (Dual Inline Memory Module) as an example of a semiconductor integrated circuit to which the clock signal providing circuit designing method in the embodiment was applied. An operating frequency of the memory controller may exceed the order of GHz, for example.

The Applicant carried out the clock signal providing circuit designing method in the embodiment in a process of designing a circuit of the memory controller. More specifically, the clock signal providing circuit designing method was realized in a computer program, circuit design of inserting clock buffers and providing clock lines was automated, and thus, the clock signal providing circuit designing method was carried out.

As a result, clock skew between FFs could be reduced. Further, designing work concerning set-up timing, holding timing and so forth could be easily carried out. Further, as a result of the automating, man-hours required for effective grouping of FFs to create one or more groups of the FFs, gate entry, skew adjustment, timing adjustment, disposition and so forth could be reduced. Thus, it was confirmed that reduction in a LSI developing period and reduction of a LSI developing cost may be achieved.

FIG. 16 depicts a block diagram illustrating a configuration of a computer which may be applied in a case where the clock signal providing circuit designing method in the embodiment is realized in a computer program.

As depicted in FIG. 16, the computer 500 includes a CPU 501 for performing various operations by executing a given computer program, and an operating part 502 including a keyboard, a mouse and so forth for a user to input instructions or data. The computer 500 further includes a display part 504 such as a CRT, a liquid crystal display device or such, to display to the user processing contents, processing results and so forth. The computer 500 further includes a memory 504 (storage unit) for storing the computer program, data and so forth, or used as a working area by the CPU 501. The computer 500 further includes a hard disk drive 505 (storage unit) for storing the computer program, data and so forth. The computer 500 further includes a CD-ROM drive 506 for loading the computer program, data and so forth, by using a CD-ROM 507 as a computer-readable information recording medium. The computer 500 further includes a modem 508 for downloading the computer program, data and so forth, by using a communication network 509 such as the Internet, LAN or such.

The computer 500 may use the CD-ROM 507 or the communication network 509, to load or download a computer program prepared for the CPU 501 to perform the clock signal providing circuit designing method in the embodiment. The computer program is installed in the hard disk drive 505, is loaded in the memory 504 from the hard disk drive 505, and is executed by the CPU 501. As a result, the computer carries out the clock signal providing circuit designing method in the embodiment automatically.

It is noted that, the clock signal providing circuit designing method in the embodiment is not limited to the above-described method for designing a clock signal providing circuit providing clock signals to FFs. The clock signal providing circuit designing method in the embodiment may also be applied to a method for providing clock signals to circuit elements other than FFs.

Further, in the clock signal providing circuit designing method in the embodiment, the optimization 1 (exchange) step S200, the optimization 2 (move) step S300 and the optimization 3. (combine) step S400 are carried out in the stated order. However, the order of carrying out the optimization 1 (exchange) step S200, the optimization 2 (move) step S300 and the optimization 3 (combine) step S400 is not limited to this, and the optimization 1 (exchange) step S200, the optimization 2 (move) step S300 and the optimization 3 (combine) step S400 may be carried out in a different order.

Further, in the embodiment, all of the optimization 1 (exchange) step S200, the optimization 2 (move) step S300 and the optimization 3 (combine) step S400 are included as depicted in FIG. 2. However, in a possible variant embodiment, only any one or any two of the three optimization steps, i.e., the optimization 1 (exchange) step S200, the optimization 2 (move) step S300 and the optimization 3 (combine) step S400, may be included.

All examples and conditional language recited herein are intended for pedagogical purposes to aid the reader in understanding the invention and the concepts contributed by the inventor to furthering the art, and are to be construed as being without limitation to such specifically recited examples and conditions, nor does the organization of such examples in the specification relate to a showing of the superiority and inferiority of the invention. Although the embodiments of the present invention have been described in detail, it should be understood that various changes, substitutions, and alterations could be made hereto without departing from the spirit and scope of the invention.

What is claimed is:

1. A clock signal providing circuit designing method for designing a clock signal providing circuit comprising:
grouping circuit elements into a plurality of circuit groups each of which includes a plurality of circuit elements, wherein the clock signal providing circuit provides a clock signal to each of the plurality of circuit elements included in each of the plurality of circuit groups by using a clock buffer provided for each of the plurality of circuit groups;
calculating an evaluation index value for each of the plurality of circuit groups and summing up calculated evaluation index values for all of the plurality of circuit groups to obtain a first sum total;
exchanging or moving provisionally at least one circuit element of the plurality of circuit elements between the plurality of circuit groups;
calculating an evaluation index value for each of the plurality of circuit groups and summing up calculated evaluation index values for all of the plurality of circuit groups to obtain a second sum total;
determining whether the second sum total decreases from the first sum total;
fixing the circuit element provisionally exchanged or moved in a case where the second sum total decreases from the first sum total; and cancelling the circuit element provisionally exchanged or moved in a case where the second sum total increases from the first sum total.

2. The clock signal providing circuit designing method according to claim 1, wherein the evaluation index values is one of:
a sum total of Manhattan distances each between a position of each circuit element belonging to a circuit group of the plurality of circuit groups and a center of the circuit group,
a sum total of Euclidian distances each between a position of each circuit element belonging to a circuit group and a center of the circuit group,
a sum total of wiring lengths from a clock buffer of a circuit group to respective ones of circuit elements belonging to the circuit group,
a gate capacity of a clock buffer of a circuit group, a sum total of capacitances of wiring from the clock buffer to respective ones of circuit elements and capacitances of clock signal input terminals of the respective ones of the circuit elements, and
a sum total of delays occurring from a clock buffer to clock signal input terminals of respective ones of circuit elements.

3. The clock signal providing circuit designing method according to claim 1, wherein:
the grouping circuit elements into a plurality of circuit groups comprises
selecting a circuit element of the plurality of circuit elements;
creating a circuit group to which the circuit element belongs in a case where the circuit element has not belonged to any circuit group;
determining based on a position of the circuit element an area of the circuit group including the circuit element;
including the circuit element in a circuit group in a case where the circuit element is located in an area of the circuit group, and a number of circuit elements belonging to the circuit group is within a permissible fanout; and
updating the area of the circuit group based on respective locations of the circuit elements belonging to the circuit group.

4. The clock signal providing circuit designing method according to claim 1, wherein:
the exchanging or moving provisionally at least one circuit element comprises exchanging or moving at least one circuit element, and combining two circuit groups of the plurality of circuit groups in one circuit group, and the combining is carried out in a case where circuit elements of each of the two circuit groups are included in an area of the other of the two circuit groups, and a number of circuit elements belonging to the two circuit groups falls within the permissible fanout.

5. The clock signal providing circuit designing method according to claim 1, wherein:
the circuit element exchanged provisionally is fixed in a case where respective areas of two circuit groups overlap each other and the second sum total decreases from the first sum total; and
the circuit element moved provisionally is fixed in a case where respective areas of two circuit groups overlap each other and the second sum total decreases the most from the first sum total.

6. A computer-readable medium containing a program including instructions, which instructions when executed by a computer processor perform a method for designing a clock signal providing circuit, the method comprising:
grouping circuit elements into a plurality of circuit groups each of which includes a plurality of circuit elements, wherein the clock signal providing circuit provides a clock signal to each of the plurality of circuit elements included in each of the plurality of circuit groups by using a clock buffer provided for each of the plurality of circuit groups;
calculating an evaluation index value for each of the plurality of circuit groups and summing up calculated evaluation index values for all of the plurality of circuit groups to obtain a first sum total;
exchanging or moving provisionally at least one circuit element of the plurality of circuit elements between the plurality of circuit groups;
calculating an evaluation index value for each of the plurality of circuit groups and summing up calculated evaluation index values for all of the plurality of circuit groups to obtain a second sum total;
determining whether the second sum total decreases from the first sum total;
fixing the circuit element provisionally exchanged or moved in a case where the second sum total decreases from the first sum total; and
cancelling the circuit element provisionally exchanged or moved in a case where the second sum total increases from the first sum total.

7. The computer-readable medium according to claim 6, wherein the evaluation index values is one of:
a sum total of Manhattan distances each between a position of each circuit element belonging to a circuit group of the plurality of circuit groups and a center of the circuit group,
a sum total of Euclidian distances each between a position of each circuit element belonging to a circuit group and a center of the circuit group,
a sum total of wiring lengths from a clock buffer of a circuit group to respective ones of circuit elements belonging to the circuit group,
a gate capacity of a clock buffer of a circuit group, a sum total of capacitances of wiring from the clock buffer to respective ones of circuit elements and capacitances of clock signal input terminals of the respective ones of the circuit elements, and
a sum total of delays occurring from a clock buffer to clock signal input terminals of respective ones of circuit elements.

8. The computer-readable medium according to claim 6, wherein:
the grouping circuit elements into a plurality of circuit groups comprises
selecting a circuit element of the plurality of circuit elements;
creating a circuit group to which the circuit element belongs in a case where the circuit element has not belonged to any circuit group;
determining based on a position of the circuit element an area of the circuit group including the circuit element;
including the circuit element in a circuit group in a case where the circuit element is located in an area of the circuit group, and a number of circuit elements belonging to the circuit group is within a permissible fanout; and
updating the area of the circuit group based on respective locations of the circuit elements belonging to the circuit group.

9. The computer-readable medium according to claim 6, wherein:
the exchanging or moving provisionally at least one circuit element comprises exchanging or moving at least one circuit element, and combining two circuit groups of the plurality of circuit groups in one circuit group, and the combining is carried out in a case where circuit elements of each of the two circuit groups are included in an area of the other of the two circuit groups, and a number of circuit elements belonging to the two circuit groups falls within the permissible fanout.

10. The computer-readable medium according to claim 6, wherein:
the circuit element exchanged provisionally is fixed in a case where respective areas of two circuit groups overlap each other and the second sum total decreases from the first sum total; and
the circuit element moved provisionally is fixed in a case where respective areas of two circuit groups overlap each other and the second sum total decreases the most from the first sum total.

11. An information processing apparatus for designing a clock signal providing circuit, the information processing apparatus comprising:
a grouping processing part configured to group circuit elements into a plurality of circuit groups each of which includes a plurality of circuit elements, wherein the clock signal providing circuit provides a clock signal to each of the plurality of circuit elements included in each of the plurality of circuit groups by using a clock buffer provided for each of the plurality of circuit groups;
an optimizing processing part configured to carry out exchanging or moving provisionally at least one circuit element of the plurality of circuit elements between the plurality of circuit groups;
an evaluating processing part configured to calculate an evaluation index value for each of the plurality of circuit groups and summing up calculated evaluation index values for all of the plurality of circuit groups to obtain a first sum total and a second sum total; and
a determining processing part configured to determine whether the second sum total decreases from the first sum total, to fix the circuit element provisionally exchanged or moved in a case where the second sum total decreases from the first sum total and to cancel the circuit element provisionally exchanged or moved in a case where the second sum total increases from the first sum total.

12. The information processing apparatus according to claim 11, wherein the evaluation index values is one of:
a sum total of Manhattan distances each between a position of each circuit element belonging to a circuit group of the plurality of circuit groups and a center of the circuit group,
a sum total of Euclidian distances each between a position of each circuit element belonging to a circuit group and a center of the circuit group,
a sum total of wiring lengths from a clock buffer of a circuit group to respective ones of circuit elements belonging to the circuit group,
a gate capacity of a clock buffer of a circuit group, a sum total of capacitances of wiring from the clock buffer to respective ones of circuit elements and capacitances of clock signal input terminals of the respective ones of the circuit elements, and
a sum total of delays occurring from a clock buffer to clock signal input terminals of respective ones of circuit elements.

13. The information processing apparatus according to claim 11, wherein:
to group circuit elements into a plurality of circuit groups comprises:
to select a circuit element of the plurality of circuit elements;
to create a circuit group to which the circuit element belongs in a case where the circuit element has not belonged to circuit any group;
to determine based on a position of the circuit element an area of the circuit group including the circuit element;
to include the circuit element in a circuit group in a case where the circuit element is located in an area of the circuit group, and a number of circuit elements belonging to the circuit group falls within a permissible fanout; and
to update the area of the circuit group based on respective locations of the circuit elements belonging to the circuit group.

14. The information processing apparatus according to claim 11, wherein:
the exchanging or moving provisionally at least one circuit element comprises exchanging or moving at least one circuit element, and combining two circuit groups of the plurality of circuit groups in one circuit group, and the combining is carried out in a case where circuit elements of each of the two circuit groups are included in an area of the other of the two circuit groups, and a number of circuit elements belonging to the two circuit groups falls within the permissible fanout.

15. The information processing apparatus according to claim 11, wherein:
the circuit element exchanged provisionally is fixed in a case where respective areas of two circuit groups overlap each other and the second sum total decreases from the first sum total; and
the circuit element moved provisionally is fixed in a case where respective areas of two circuit groups overlap each other and the second sum total decreases the most from the first sum total.
